(19) United States
(12) Patent Application Publication
(10) Pub. No.: US 2025/0279646 A1
(43) Pub. Date: Sep. 4, 2025

(54) OVERCURRENT PROTECTION FOR A LOAD CONTROL DEVICE

(71) Applicant: Lutron Technology Company LLC, Coopersburg, PA (US)

(72) Inventor: Donald F. Hausman, JR., New Tripoli, PA (US)

(73) Assignee: Lutron Technology Company LLC, Coopersburg, PA (US)

(21) Appl. No.: 19/067,302

(22) Filed: Feb. 28, 2025

Related U.S. Application Data
(60) Provisional application No. 63/560,212, filed on Mar. 1, 2024.

(51) Int. Cl. H02H 9/02; H02J 3/00; H02J 3/14

(52) U.S. Cl. CPC H02H 9/025; H02J 3/00125; H02J 3/14

(57) ABSTRACT

A load control device may include a closed-loop gate drive circuit coupled to a semiconductor switch and configured to render the semiconductor switch conductive or non-conductive at a control time during half-cycles of an AC mains line voltage. The gate drive circuit may limit a magnitude of the load current conducted through the semiconductor switch to a maximum current limit. The load control device may include a control circuit that is configured to set the maximum current limit to a second magnitude for a period of time following a control time of the semiconductor switch during a conduction period of a half-cycle of the AC mains line voltage, and set the maximum current limit to a first magnitude after the expiration of the period of time during the conduction period of the half-cycle of the AC mains line voltage.

### CROSS-REFERENCE TO RELATED APPLICATION

This application claims priority from Provisional U.S. Patent Application No. 63/560,212, filed Mar. 1, 2024, the entire disclosure of which is hereby incorporated by reference herein in its entirety.

### BACKGROUND

Prior art load control devices, such as dimmer switches, may be coupled in series electrical connection between an alternating-current (AC) power source and a lighting load for controlling the amount of power delivered from the AC power source to the lighting load. A standard dimmer switch may typically comprise a bidirectional semiconductor switch, e.g., a thyristor (e.g., such as a triac) or two field-effect transistors (FETs) in anti-series connection. The bidirectional semiconductor switch may be coupled in series between the AC power source and the load. The bidirectional semiconductor switch may be controlled to be conductive and non-conductive for portions of a half-cycle of the AC power source to thus control the amount of power delivered to the electrical load.

Generally, dimmer switches may use either a forward phase-control dimming technique or a reverse phase-control dimming technique in order to control when the bidirectional semiconductor switch is rendered conductive and non-conductive to thus control the power delivered to the load. The dimmer switch may comprise a toggle actuator for turning the lighting load on and off and an intensity adjustment actuator for adjusting the intensity level of the lighting load. Examples of prior art dimmer switches are described in greater detail is commonly-assigned U.S. Pat. No. 5,248,919, issued Sep. 29, 1993, entitled LIGHTING CONTROL DEVICE; and U.S. Pat. No. 6,969,959, issued Nov. 29, 2005, entitled ELECTRONIC CONTROL SYSTEMS AND METHODS; the entire disclosures of which are incorporated by reference herein.

### SUMMARY

As described herein, a load control device may be configured to control power delivered from an alternating-current (AC) power source to an electrical load. The load control device may include a controllably conductive device adapted to be coupled in series between the AC power source and the electrical load. The AC power source may be configured to generate an AC mains line voltage. The controllably conductive device may include a semiconductor switch configured to conduct a load current through the electrical load. The load control device may include a closed-loop gate drive circuit coupled to the semiconductor switch and configured to render the semiconductor switch conductive or non-conductive at a control time during half-cycles of the AC mains line voltage. The closed-loop gate drive circuit may be configured to limit a magnitude of the load current conducted through the semiconductor switch to a maximum current limit. The load control device may include a control circuit that is configured to generate a drive signal to adjust the control time of the semiconductor switch during each half-cycle of the AC mains line voltage to control the amount of power delivered to the electrical load. The control circuit may be configured to control the drive signal to render the semiconductor switch conductive at a control time during a half-cycle of the AC mains line voltage to maintain the semiconductor switch conductive for a conduction period during the half-cycle of the AC mains line voltage. The control circuit may set the maximum current limit of the closed-loop gate drive circuit to a first limit for a period of time following the control time during the conduction period of the half-cycle of the AC mains line voltage. The control circuit may set the maximum current limit of the closed-loop gate drive circuit to a second limit after the expiration of the period of time during the conduction period of the half-cycle of the AC mains line voltage, wherein the second limit is less than the first limit.

The control circuit may be configured to set the maximum current limit to the first limit for a pulse period that starts at the control time during the half-cycle of the AC mains line voltage, and set the maximum current limit to the second limit at the end of the pulse period and during a remainer of the conduction period of the half-cycle of the AC mains line voltage. The pulse period may be approximately 500 microseconds. The control circuit may be configured to set the maximum current limit to the first limit for the pulse period to allow for a capacitance of a capacitive load to charge during the half-cycle of the AC mains line voltage.

The control circuit may be configured to set the maximum current limit of the closed-loop gate drive circuit to the first limit for the pulse period following the control time of the semiconductor switch during an amount of time (e.g., an initial plurality of half-cycles of the AC mains line voltage) after turning on the electrical load, and after the initial plurality of half-cycles of the AC mains line voltage, set the maximum current limit of the closed-loop gate drive circuit to the second limit at the control time during subsequent half-cycles of the AC mains line voltage after the initial plurality of half-cycles and while controlling power to the electrical load. The control circuit may be configured to shorten a duration of the pulse period over the initial plurality of half-cycles of the AC mains line voltage after turning on the electrical load.

The control circuit is configured to set a length of the pulse period to a second time period for a number of half-cycles after turning on the electrical load, and set the length of the pulse period to a first time period after the number of half-cycles and while controlling power to the electrical load. The first time period may be approximately 500 microseconds, the second time period may be approximately 2,000 microseconds, and/or the number of half-cycles may be approximately 120 half-cycles.

The control circuit may be configured to adjust the maximum current limit across a range of values from the first limit to the second limit over a plurality of half-cycles of the AC mains line voltage. The control circuit may be configured to linearly reduce the maximum current limit across the range of values from the first limit to the second limit over the plurality of half-cycles of the AC mains line voltage.

When operating in a forward phase-control technique, the control circuit may be configured to set the maximum current limit of the closed-loop gate drive circuit to the first limit for the period of time following the control time of the semiconductor switch during a conduction period of each half-cycle of the AC mains line voltage while controlling power to the electrical load. The control circuit may set the maximum current limit of the closed-loop gate drive circuit to the second limit after the expiration of the period of time during the conduction period of each half-cycle of the AC mains line voltage while controlling power to the electrical load. For example, when operating in a reverse phase-control technique, the control circuit may be configured to set the maximum current limit of the closed-loop gate drive circuit to a third limit during the entire conduction period of each half-cycle of the AC mains line voltage while controlling power to the electrical load. The third limit may be equal to the first limit.

The closed-loop gate drive circuit may be configured to generate a target signal in response to the control circuit, receive a feedback signal indicative of a magnitude of the load current conducted through the semiconductor switch, and generate a gate control signal in response to the target signal and the feedback signal. The semiconductor switch of the controllably conductive device may be configured to be rendered conductive and non-conductive in response to the gate control signal.

When using a forward phase-control technique, the control circuit may be configured to control the drive signal to render the semiconductor switch non-conductive at a beginning of each half-cycle of the AC mains line voltage, and control the drive signal to render the semiconductor switch conductive at the control time during the each half-cycle of the AC mains line voltage and throughout a remainder of each half-cycle of the AC mains line voltage while controlling power to the electrical load. For example, when using a reverse phase-control technique, the control circuit may be configured to control the drive signal to render the semiconductor switches conductive at the beginning of each half-cycle of the AC mains line voltage, and control the drive signal to render the semiconductor switch non-conductive at the control time during each half-cycle of the AC mains line voltage.

The control circuit may be configured to control the semiconductor switch to be non-conductive for a non-conduction period and conductive for a conduction period during one or more half-cycles of the AC mains line voltage to control the amount of power delivered to the electrical load.

Some examples may include a load control device that is configured to control power delivered from an alternating-current (AC) power source to an electrical load, where the load control device includes a controllably conductive device adapted to be coupled in series between the AC power source and the electrical load, where the AC power source is configured to generate an AC mains line voltage, and where the controllably conductive device comprises a semiconductor switch configured to conduct a load current through the electrical load. The load control device may include a closed-loop gate drive circuit coupled to the semiconductor switch and that is configured to render the semiconductor switch conductive or non-conductive at a control time during half-cycles of the AC mains line voltage. The closed-loop gate drive circuit may be configured to limit a magnitude of the load current conducted through the semiconductor switch to a maximum current limit, where the maximum current limit may be adjustable between a first limit and a second limit. The load control device may include a control circuit that is configured to generate a drive signal to adjust the control time of the semiconductor switch during each half-cycle of the AC mains line voltage to control the amount of power delivered to the electrical load, determine that the electrical load is an inductive load, and set the maximum current limit of the closed-loop gate drive circuit to the second limit based on the electrical load being an inductive load.

The control circuit may be configured to determine that the electrical load is an inductive load based on a magnitude of the load current conducted through the semiconductor switch being out of phase with the AC mains line voltage. The load control device may include a zero-cross detection signal that is configured to generates a zero-cross signal that indicates zero crossing points of the AC mains line voltage, and a feedback resistor that is coupled in series with the semiconductor switch and configured to generate a feedback signal. The control circuit may be configured to determine the zero-crossing points of the AC mains line voltage based on the zero-cross signal generated by the zero-cross detection signal, and determine the zero-crossing points of the load current conducted through the semiconductor switch based on the feedback signal generated by the feedback resistor. The control device may be configured to determine that the load current conducted through the semiconductor switch is out of phase with the AC mains line voltage when zero-crossings of the load current conducted through the semiconductor switch do not align with zero-crossings of the AC mains line voltage.

The control circuit may be configured to determine to operate in the forward phase-control technique based on the electrical load being an inductive load. The control circuit may be configured to detect whether to operate accordingly to a reverse phase-control technique or a forward phase-control technique based on the electrical load and, when operating in the reverse phase-control technique, the control circuit may be configured to set the maximum current limit of the closed-loop gate drive circuit to the first limit. For example, when operating in the forward phase-control technique and based on the electrical load not being an inductive load, the control circuit may be configured to set the maximum current limit of the closed-loop gate drive circuit to the first limit. When operating in the forward phase-control technique and based on the electrical load not being an inductive load, the control circuit may be configured to set the maximum current limit of the closed-loop gate drive circuit to the first limit for a period of time following the control time during a conduction period of the half-cycle of the AC mains line voltage and set the maximum current limit to the second limit after the expiration of the period of time during the conduction period of a half-cycle of the AC mains line voltage.

Some examples may include a load control device that is configured to control power delivered from an alternating-current (AC) power source to an electrical load, where the load control device includes a controllably conductive device that is adapted to be coupled in series between the AC power source and the electrical load, where the AC power source is configured to generate an AC mains line voltage, and where the controllably conductive device comprises a semiconductor switch configured to conduct a load current through the electrical load. The load control device may include a closed-loop gate drive circuit that is coupled to the semiconductor switch and configured to render the semiconductor switch conductive or non-conductive at a control time during half-cycles of the AC mains line voltage, where the closed-loop gate drive circuit is configured to limit a magnitude of the load current conducted through the semiconductor switch to a maximum current limit. The load control device may include a control circuit that is configured to, for an initial plurality of half-cycles of the AC mains line voltage after turning on the electrical load, set the maximum current limit of the closed-loop gate drive circuit to a first limit for a period of time following a control time of the semiconductor switch during a conduction period of each half-cycle of the AC mains line voltage of the initial plurality of half-cycles, and set the maximum current limit of the closed-loop gate drive circuit to a second limit after the expiration of the period of time during the conduction period of each of the half-cycles of the AC mains line voltage of the initial plurality of half-cycles, wherein the second limit is less than the first limit. The control circuit may be configured to, after the initial plurality of half-cycles of the AC mains line voltage, set the maximum current limit of the closed-loop gate drive circuit to the second limit at the control time and during the entire conduction period of during subsequent half-cycles of the AC mains line voltage after the initial plurality of half-cycles while controlling power to the electrical load.

Some examples may include a load control device that is configured to control power delivered from an alternating-current (AC) power source to an electrical load, where the load control device includes a controllably conductive device that is adapted to be coupled in series between the AC power source and the electrical load, where the AC power source is configured to generate an AC mains line voltage, and where the controllably conductive device comprises a semiconductor switch configured to conduct a load current through the electrical load. The load control device may also include a control circuit that is configured to generate a drive signal to adjust a control time of the semiconductor switch during each half-cycle of the AC mains line voltage to control the amount of power delivered to the electrical load. The load control device may include a closed-loop gate drive circuit coupled to the semiconductor switch, where the closed-loop gate drive circuit is configured to receive the drive signal from the control circuit, render the semiconductor switch conductive or non-conductive at the control time in response to the drive signal during half-cycles of the AC mains line voltage, and limit a magnitude of the load current conducted through the semiconductor switch to a maximum current limit. The closed-loop gate drive circuit may be configured to adjust the maximum current limit from a first limit to a second limit during a conduction period of a half-cycle of the AC mains line voltage. In some examples, the second limit is less than the first limit. In some examples, the closed-loop gate drive circuit may be configured to render the semiconductor switch conductive at the control time when operating in a forward phase-control technique, and render the semiconductor switch non-conductive at the control time when operating in a reverse phase-control technique.

A method may be performed by a load control device that is configured to control power delivered from an alternating-current (AC) power source to an electrical load. The method may include generating a drive signal to adjust a control time of a semiconductor switch of the load control device during each half-cycle of a AC mains line voltage to control an amount of power delivered to the electrical load. The method may include controlling the drive signal to render the semiconductor switch conductive at a control time during a half-cycle of the AC mains line voltage to maintain the semiconductor switch conductive for a conduction period during the half-cycle of the AC mains line voltage. The method may include setting a maximum current limit of a closed-loop gate drive circuit to a first limit for a period of time following the control time during the conduction period of the half-cycle of the AC mains line voltage, wherein the closed-loop gate drive circuit is configured to limit a magnitude of the load current conducted through the semiconductor switch to the maximum current limit. The method may include setting the maximum current limit of the closed-loop gate drive circuit to a second limit after an expiration of the period of time during the conduction period of the half-cycle of the AC mains line voltage, wherein the second limit is less than the first limit.

The method may include setting the maximum current limit to the first limit for a pulse period that starts at the control time during the half-cycle of the AC mains line voltage. The method may include setting the maximum current limit to the second limit at an end of the pulse period and during a remainer of the conduction period of the half-cycle of the AC mains line voltage. The pulse period may be approximately 500 microseconds. The method may include setting the maximum current limit to the first limit for the pulse period to allow for a capacitance of a capacitive load to charge during the half-cycle of the AC mains line voltage.

The method may include setting the maximum current limit of the closed-loop gate drive circuit to the first limit for the pulse period following the control time of the semiconductor switch during an initial plurality of half-cycles of the AC mains line voltage after turning on the electrical load. The method may include after the initial plurality of half-cycles of the AC mains line voltage, setting the maximum current limit of the closed-loop gate drive circuit to the second limit at the control time during subsequent half-cycles of the AC mains line voltage after the initial plurality of half-cycles and while controlling power to the electrical load.

The method may include shortening a duration of the pulse period over the initial plurality of half-cycles of the AC mains line voltage after turning on the electrical load.

The method may include setting a length of the pulse period to a second time period for a number of half-cycles after turning on the electrical load. The method may include setting the length of the pulse period to a first time period after the number of half-cycles and while controlling power to the electrical load. In some examples, the first time period is approximately 500 microseconds, the second time period is approximately 2,000 microseconds, and the number of half-cycles is approximately 120 half-cycles.

The method may include adjusting the maximum current limit across a range of values from the first limit to the second limit over a plurality of half-cycles of the AC mains line voltage. The method may include linearly reducing the maximum current limit across the range of values from the first limit to the second limit over the plurality of half-cycles of the AC mains line voltage.

When operating in a forward phase-control technique, the method may include setting the maximum current limit of the closed-loop gate drive circuit to the first limit for the period of time following the control time of the semiconductor switch during a conduction period of each half-cycle of the AC mains line voltage while controlling power to the electrical load; and setting the maximum current limit of the closed-loop gate drive circuit to the second limit after an expiration of the period of time during the conduction period of each half-cycle of the AC mains line voltage while controlling power to the electrical load.

When operating in a reverse phase-control technique, the method may include setting the maximum current limit of the closed-loop gate drive circuit to a third limit during the entire conduction period of each half-cycle of the AC mains line voltage while controlling power to the electrical load. In some examples, the third limit is equal to the first limit.

When using a forward phase-control technique, the method may include controlling the drive signal to render the semiconductor switch non-conductive at a beginning of each half-cycle of the AC mains line voltage; and controlling the drive signal to render the semiconductor switch conductive at the control time during the each half-cycle of the AC mains line voltage and throughout a remainder of each half-cycle of the AC mains line voltage while controlling power to the electrical load. When using a reverse phase-control technique, the method may include controlling the drive signal to render the semiconductor switches conductive at the beginning of each half-cycle of the AC mains line voltage; and controlling the drive signal to render the semiconductor switch non-conductive at the control time during each half-cycle of the AC mains line voltage.

The method may include controlling the semiconductor switch to be non-conductive for a non-conduction period and conductive for a conduction period during one or more half-cycles of the AC mains line voltage to control the amount of power delivered to the electrical load.

### BRIEF DESCRIPTION OF THE DRAWINGS

FIG. 1 is a block diagram of an example load control device for controlling the amount of power delivered to an electrical load.

FIG. 2 is a block diagram of an example gate drive circuit configured to control the amount of power delivered to an electrical load.

FIG. 3 shows examples of waveforms that illustrate operation of a load control device using a forward phase-control dimming technique.

FIG. 4 shows examples of waveforms that illustrate operation of a load control device using a reverse phase-control dimming technique.

FIG. 5 shows examples of waveforms that illustrate operation of a gate drive circuit to render a semiconductor switch conductive using a forward phase-control dimming technique.

FIG. 6 shows examples of waveforms that illustrate operation of a gate drive circuit to render a semiconductor switch conductive using a reverse phase-control dimming technique.

FIG. 7 shows examples of waveforms that illustrate operation of a gate drive circuit to render a semiconductor switch conductive using a forward phase-control dimming technique and a limit signal set to a first magnitude.

FIG. 8 shows examples of waveforms that illustrate operation of a gate drive circuit to render a semiconductor switch conductive using a forward phase-control dimming technique and a limit signal adjusted between a second magnitude and a first magnitude during a conduction period of a half-cycle of an AC mains line voltage.

FIG. 9 shows examples of waveforms that illustrate another example operation of a gate drive circuit to render a semiconductor switch conductive using a forward phase-control dimming technique and a limit signal adjusted between a second magnitude and a first magnitude during a conduction period of a half-cycle of an AC mains line voltage.

FIG. 10 shows examples of waveforms that illustrate operation of a gate drive circuit to render a semiconductor switch conductive using a forward phase-control dimming technique and a limit signal linearly adjusted between a second magnitude and a first magnitude during a conduction period of a half-cycle of an AC mains line voltage.

FIG. 11A is a flowchart of an example procedure for setting the maximum current limit of a load control device based on the type of phase-control technique configured by the load control device.

FIG. 11B is a flowchart of an example procedure for setting the maximum current limit of a load control device based on the type of phase-control technique configured by the load control device.

FIG. 11C is a flowchart of an example procedure for adjusting a pulse period of a maximum current limit of a load control device in response to receiving a command to turn on the electrical load.

FIG. 12 is a flowchart of an example procedure for controlling a maximum current limit of a load control device based on whether an electrical load coupled to the load control device is an inductive load.

### DETAILED DESCRIPTION

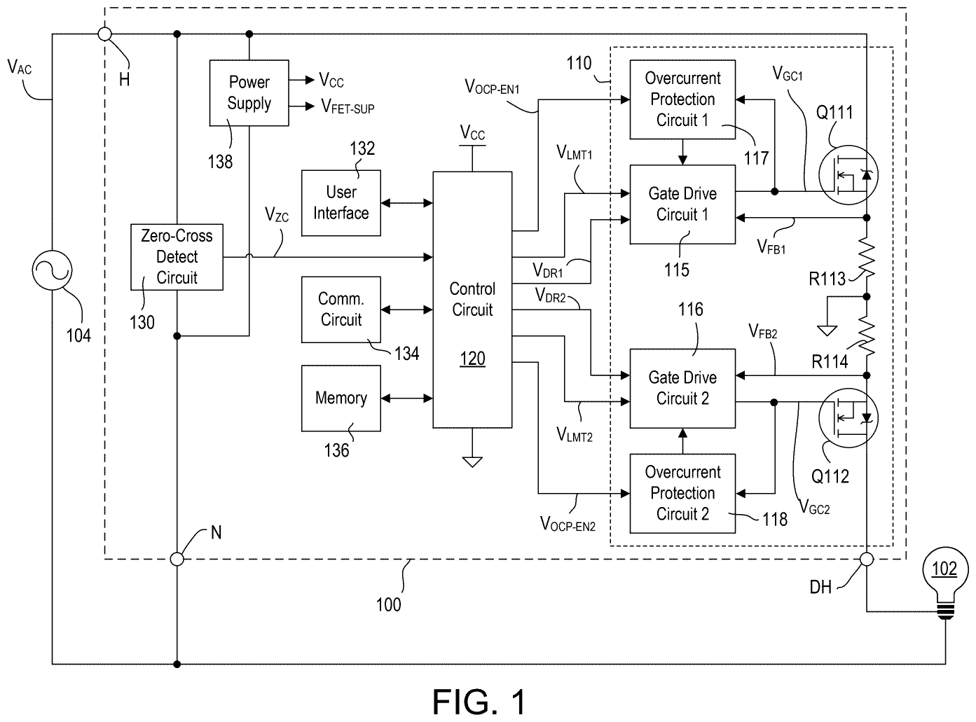

FIG. 1 is a block diagram of an example load control device 100 (e.g., a dimmer switch) for controlling an amount of power delivered from an alternating-current (AC) power source 104 to an electrical load, such as a lighting load 102. The load control device 100 may include a hot terminal H coupled to a hot side of the AC power source 104 for receiving an AC mains line voltage V_{AC}, and a dimmed-hot terminal DH coupled to the lighting load 102. The load control device 100 may also include a neutral terminal N that may be adapted to be coupled to a neutral side of the AC power source 104.

The load control device 100 may comprise a load regulation circuit 110 (e.g., a dimming circuit). For example, the load regulation circuit 110 may comprise a controllably conductive device having one or more semiconductor switches, such as two field-effect transistors (FETs) Q111, Q112. The FETs Q111, Q112 may be coupled in anti-series connection between the hot terminal H and the dimmed-hot terminal DH. The load regulation circuit 110 may also include a first feedback circuit, such as a first sense resistor R113, coupled in series with the first FET Q111, and a second feedback circuit, such as a second sense resistor R114, coupled in series with the second FET Q112. The junction of the first and second sense resistors R113, R114 may be coupled to circuit common. In some examples, the controllably conductive device of the load regulation circuit 110 may comprise a single FET in a full-wave bridge rectifier (e.g., coupled between the hot terminal H and the dimmed-hot terminal DH) and the load regulation circuit 110 may comprise a single closed-loop gate drive circuit.

The load control device 100 may comprise a control circuit 120, e.g., a digital control circuit, for controlling the load regulation circuit 110 to conduct a load current I_{LOAD} through the lighting load 102 to adjust a present intensity level L_{PRES} of the lighting load 102. For example, the control circuit 120 may be configured to adjust the present intensity level L_{PRES} of the lighting load 102 between a high-end intensity level L_{HE} (e.g., approximately 100%) and a low-end intensity level L_{LE} (e.g., approximately 0.1-5%). The control circuit 120 may include one or more of a processor (e.g., a microprocessor), a microcontroller, a programmable logic device (PLD), a field programmable gate array (FPGA), an application specific integrated circuit (ASIC), or any suitable controller or processing device. The control circuit 120 may be configured to control the controllably conductive device of the load regulation circuit 110 to render the FETs Q111, Q112 conductive and non-conductive using a phase-control dimming technique to generate a dimmed-hot voltage V_{DH} (e.g., a phase-control voltage) across the lighting load 102 (e.g., between the dimmed-hot terminal DH and the neutral terminal N). When the first FET Q111 is conductive during the positive half-cycles of the AC mains line voltage V_{AC}, the first FET Q111 may be configured to conduct the load current I_{LOAD} (e.g., a first portion of the load current I_{LOAD}) from the hot terminal H through the first sense resistor R113 to circuit common, and then through the second sense resistor R114 and a body diode of the second FET Q112 to the dimmed-hot terminal DH. When the second FET Q112 is conductive during the negative half-cycles of the AC mains line voltage V_{AC}, the second FET Q112 may be configured to conduct the load current I_{LOAD} (e.g., a second portion of the load current I_{LOAD}) from the dimmed-hot terminal DH through the second sense resistor R114 to circuit common, and then through the first sense resistor R113 and a body diode of the first FET Q111 to the hot terminal H.

The control circuit 120 may be configured to determine times of zero-crossing points of the AC mains line voltage V_{AC} of the AC power source 104. For example, the load control device 100 may comprise a zero-crossing detect circuit 130 that may be coupled to the hot terminal H and the neutral terminal N, and generates a zero-cross signal V_{ZC} that indicates the zero-crossing points of the AC mains line voltage V_{AC}. The control circuit 120 may then render the FETs Q111, Q112 of the load regulation circuit 110 conductive and/or non-conductive at predetermined times (e.g., at a firing time or firing angle) relative to the zero-crossing points of the AC mains line voltage V_{AC} (e.g., as determined from the zero-cross signal V_{ZC}) to generate the dimmed-hot voltage V_{DH} using the phase-control dimming technique, e.g., such as, a forward phase-control dimming technique and/or a reverse phase-control dimming technique. For example, the control circuit 120 may use the forward phase-control dimming technique to control inductive loads and may use the reverse phase-control dimming technique to control capacitive loads. During each half-cycle of the dimmed-hot voltage V_{DH}, the control circuit 120 may be configured to control the controllably conductive device of the load regulation circuit 110 (e.g., the FETs Q111, Q112) to be non-conductive for a non-conduction period and conductive for a conduction period. In addition, the control circuit 120 may be configured to control the controllably conductive device of the load regulation circuit 110 between the non-conductive state and the conductive state during a transition period (e.g., a switching period) between the non-conduction period and the condition period. Examples of dimmer switches are described in greater detail in commonly-assigned U.S. Pat. No. 8,664,881, issued Mar. 4, 2014, entitled TWO-WIRE DIMMER SWITCH FOR LOW-POWER LOADS, the entire disclosure of which is incorporated by reference herein.

The control circuit 120 may be configured to adjust a control time (e.g., a firing time or a phase angle) each half-cycle of the dimmed-hot voltage V_{DH} generated across the lighting load 102 each half-cycle to control the amount of power delivered to the lighting load 102 and thus the present intensity level L_{PRES} of the lighting load 102. For example, the control circuit 120 may be configured to adjust the control time each half-cycle to adjust the present intensity level L_{PRES} of the lighting load 102 towards a target intensity level L_{TRGT}. The control circuit 120 may be configured to control the FETs Q111, Q112 using the forward phase-control dimming technique and/or the reverse phase-control dimming technique. When using the forward phase-control dimming technique, the control circuit 120 may render one or more of the FETs Q111, Q112 non-conductive (e.g., to cause the controllably conductive device of the load regulation circuit 110 to be non-conductive) at the beginning of each half-cycle of the AC mains line voltage, and then render one or more of the FETs Q111, Q112 conductive (e.g., to cause the controllably conductive device of the load regulation circuit 110 to be conductive) at the control time (e.g., the firing time) during the half-cycle after which the controllably conductive device may remain conductive until the end of the half-cycle. When using the reverse phase-control dimming technique, the control circuit 120 may render one or more of the semiconductor switches Q111, Q112 conductive (e.g., to cause the controllably conductive device of the load regulation circuit 110 to be conductive) at the beginning of each half-cycle of the AC mains line voltage, and then render one or more of the semiconductor switches Q111, Q112 non-conductive (e.g., to cause the controllably conductive device of the load regulation circuit 110 to be non-conductive) at the control time during the half-cycle after which the controllably conductive device may remain non-conductive until the end of the half-cycle.

The load regulation circuit 110 may also include a first gate drive circuit 115 (e.g., a first closed-loop gate drive circuit) coupled to a gate of the first FET Q111 for controlling the first FET Q111 and a second gate drive circuit 116 (e.g., a second closed-loop gate drive circuit) coupled to a gate of the second FET Q112 for controlling the second FET Q112. The control circuit 120 may generate, for example, first and second drive signal V_{DR1}, V_{DR2}, respectively, that may be received by the first and second gate drive circuits 115, 116, respectively, for controlling the FETs Q111, Q112. The drive signals V_{DR1}, V_{DR2} may be provided to the first and second gate drive circuits 115, 116 of the load regulation circuit 110, respectively for adjusting the control time of the dimmed-hot voltage V_{DH} generated across the lighting load 102 and/or a magnitude of the load current I_{LOAD} conducted through the lighting load 102, for example, to control the present intensity level L_{PRES} of the lighting load 102. The control circuit 120 may adjust a duty cycle (e.g., an on time) of each of the drive signals V_{DR1}, V_{DR2} (e.g., using the same duty cycle for each of the drive signals V_{DR1}, V_{DR2}) to adjust the present intensity level L_{PRES} of the lighting load 102 towards the target intensity level L_{TRGT}.

The first and the second gate drive circuits 115, 116 may receive the respective drive signals V_{DR1}, V_{DR2} from the control circuit 120 and control the respective FETs Q111, Q112 in response to the drive signals V_{DR1}, V_{DR2} to adjust the magnitude of the load current I_{LOAD} conducted through the lighting load 102. For example, the first and second gate drive circuits 115, 116 may generate respective gate control signals V_{GC1}, V_{GC2} in response to the drive signals V_{DR1}, V_{DR2}, and provide the respective gate control signals V_{GC1}, V_{GC2} to the gates of the respective FETs Q111, Q112 to render the FETs Q111, Q112 conductive and non-conductive and control the present intensity level L_{PRES} of the lighting load 102. While not shown in FIG. 1, in some examples, the load control device 100 may comprise a first buffer circuit coupled between the first gate drive circuit 115 and the gate of the first FETs Q111, and a second buffer circuit coupled between the second gate drive circuit 116 and the gate of the second FET Q112.

The load regulation circuit 110 may include first and second feedback circuits, such as a first sense resistor R113 and a second sense resistor R114, respectively. For example, the first sense resistor R113 (e.g., the first feedback circuit) may be configured to generate a first feedback signal V_{FB1}, which may have a magnitude that indicates a magnitude of the first portion of the load current I_{LOAD} that flows through the first FET Q111 during the positive half-cycles. In addition, the second sense resistor R114 (e.g., the second feedback circuit) may be configured to generate a second feedback signal V_{FB2}, which may have a magnitude that indicates a magnitude of the second portion of the load current I_{LOAD} that flows through the second FET Q112 during the negative half-cycles. Together, the first and second feedback signals V_{FB1}, V_{FB2} may indicate the magnitude of the load current I_{LOAD} that is conducted through the lighting load 102 (e.g., the sum of the first portion and the second portion of the load current I_{LOAD}). The first and second gate drive circuits 115, 116 may be configured to receive the first and second feedback signals V_{FB1}, V_{FB2}, respectively, and to generate the first and second gate control signals V_{GC1}, V_{GC2} in response to the first and second feedback signals V_{FB1}, V_{FB2}, respectively (e.g., using closed-loop control). Since the first and second gate drive circuits 115, 116 generate the first and second gate control signals V_{GC1}, V_{GC2} using closed-loop control, the magnitudes of the first and second gate control signals V_{GC1}, V_{GC2} may indicate the magnitude of the load current I_{LOAD}. Examples of a load control device that provides closed-loop control of a load current conducted through a lighting load are described in greater detail in U.S. Pat. No. 11,569,733, issued Jan. 31, 2023, entitled LOAD CONTROL DEVICE HAVING A CLOSED-LOOP GATE DRIVE CIRCUIT INCLUDING OVERCURRENT PROTECTION, the entire disclosure of which is hereby incorporated by reference.

The first gate drive circuit 115 may receive the first feedback signal V_{FB1} and may generate the first gate control signal V_{GC1} for controlling the first FET Q111 in response to the first drive signal V_{DR1} and the first feedback signal V_{FB1}. For example, the first gate drive circuit 115 may be configured to adjust the magnitude of the first gate control signal V_{GC1} in response to a magnitude of the first feedback signal V_{FB1} to adjust the magnitude of the load current I_{LOAD} towards a target current indicated by a magnitude of a first target signal V_{TRGT1} of the first gate drive circuit 115. The first gate drive circuit 115 may be configured generate the first gate control signal V_{GC1} for controlling the magnitude of the load current I_{LOAD} conducted through the first FET Q111 in response to the first target signal V_{TRGT1} and the first feedback signal V_{FB1} using closed-loop control (e.g., as described in greater detail below). The first gate drive circuit 115 may be configured to receive a first limit signal V_{LMT1}, which may also be generated by the control circuit 120. The first gate drive circuit 115 may be configured to generate the first target signal V_{TRGT1} to control the first FET Q111 during the conduction period of each half-cycle of the dimmed-hot voltage V_{DH} in response to the first limit signal V_{LMT1}. For example, the magnitude of the first target signal V_{TRGT1} of the first gate drive circuit 115 may set a first maximum current limit I_{LMT1} to which the first gate control circuit 115 may control the magnitude of the load current I_{LOAD} during the conduction period of each positive half-cycle.

The first gate drive circuit 115 may be configured to generate the first target signal V_{TRGT1} to control the first FET Q111 during the transition period of each half-cycle of the dimmed-hot voltage V_{DH} in response to the first drive signal V_{DR1}. In some examples, the first target signal V_{TRGT1} of the first gate drive circuit 115 may be a shaped (e.g., wave-shaped) target signal based on the first drive signal V_{DR1}, and the first gate drive circuit 115 may generate the first gate control signal V_{GC1} for turning on the first FET Q111 in response to the shaped target signal and the first feedback signal V_{FB1} to shade the dimmed-hot voltage V_{DH} during the transition period (e.g., as described in greater detail below). For example, the control circuit 120 may be configured to generate the first drive signal V_{DR1}, and the first gate drive circuit 115 may be configured to shape (e.g., start shaping) the first target signal V_{TRGT1} in response to the first drive signal V_{DR1}.

Similarly, the second gate drive circuit 116 may receive the second feedback signal V_{FB2} and may generate the second gate control signal V_{GC1} for controlling the first FET Q111 in response to the second drive signal V_{DR2} and the second feedback signal V_{FB2}. For example, the second gate drive circuit 116 may be configured to adjust a magnitude of the second gate control signal V_{GC2} in response to a magnitude of the second feedback signal V_{FB2} to adjust the magnitude of the load current I_{LOAD} towards a target current indicated by a magnitude of a second target signal V_{TRGT2} of the second gate drive circuit 116. The second gate drive circuit 116 may be configured generate the second gate control signal V_{GC2} for controlling the magnitude of the load current I_{LOAD} conducted through the second FET Q112 in response to the second target signal V_{TRGT2} and the second feedback signal V_{FB2} using closed-loop control (e.g., as described in greater detail below). The second gate drive circuit 116 may be configured to receive a second limit signal V_{LMT2}, which may also be generated by the control circuit 120. The second gate drive circuit 116 may be configured to generate the second target signal V_{TRGT2} to control the second FET Q112 during the conduction period of each half-cycle of the dimmed-hot voltage V_{DH} in response to the second limit signal V_{LMT2}. For example, the magnitude of the second target signal V_{TRGT2} of the second gate drive circuit 116 may set a second maximum current limit I_{LMT2} to which the second gate control circuit 116 may control the magnitude of the load current I_{LOAD} during the conduction period of each negative half-cycle.

The second gate drive circuit 116 may be configured to generate the second target signal V_{TRGT2} to control the second FET Q112 during the transition period of each half-cycle of the dimmed-hot voltage V_{DH} in response to the second drive signal V_{DR2}. In some examples, the second target signal V_{TRGT2} of the second gate drive circuit 116 may be a shaped (e.g., wave-shaped) target signal based on the second drive signal V_{DR2}, and the second gate drive circuit 116 may generate the second gate control signal V_{GC2} for turning on the second FET Q112 in response to the shaped target signal and the second feedback signal V_{FB2} to shade the dimmed-hot voltage V_{DH} during the transition period (e.g., as described in greater detail below). For example, the control circuit 120 may be configured to generate the second drive signal V_{DR2}, and the second gate drive circuit 116 may be configured to shape (e.g., start shaping) the second target signal V_{TRGT2} in response to the second drive signal V_{DR2}.

The load regulation circuit 110 (e.g., the first and second gate drive circuits 115, 116) may be configured to provide overcurrent protection (e.g., inherent overcurrent protection and/or current-limiting protection) for the load control device 100. In some examples, the first and second gate drive circuits 115, 116 may be configured to limit the magnitude of the load current I_{LOAD} conducted through the respective FETs Q111, Q112 in response to the respective gate control signal V_{GC1}, V_{GC2}. For example, when the first FET Q111 is conductive during the positive half-cycles, the first gate drive circuit 115 may be configured to limit the magnitude of the first portion of the load current I_{LOAD} conducted through the first FET Q111 to the first maximum current limit I_{LMT1} as indicated by the first limit signal V_{LMT1}. Similarly, when the second FET Q112 is conductive during the negative half-cycles, the second gate drive circuit 116 may be configured to limit the magnitude of the second portion of the load current I_{LOAD} conducted through the second FET Q112 to the second maximum current limit I_{LMT2} as indicated by the second limit signal V_{LMT2}. For example, the second maximum current limit I_{LMT2} may be equal to the first maximum current limit I_{LMT1}.

The load regulation circuit 110 may comprise first and second overcurrent protection (OCP) circuits 117, 118 for detecting overcurrent conditions in the FETs Q111, Q112, respectively, and controlling the FETs Q111, Q112, respectively, in response to detecting the overcurrent conditions. For example, the first overcurrent protection circuit 117 may be configured to detect the overcurrent condition, and render the first FET Q111 non-conductive after a first trip time period T_{TRIP1} from when the overcurrent condition is detected. Similarly, the second overcurrent protection circuit 118 may be configured to detect the overcurrent condition, and render the second FET Q112 non-conductive after a second trip time period T_{TRIP2} from when the overcurrent condition is detected. For example, the first overcurrent threshold I_{TH-OCP} may be equal to the second overcurrent threshold I_{TH-OCP2}, and the first trip time period T_{TRIP1} may be equal to the second trip time period T_{TRIP2}. The first and second overcurrent protection circuits 117, 118 may be configured to receive respective overcurrent protection (OCP) enable signals V_{OCP-EN1}, V_{OCP-EN2}, which may be generated by the control circuit 120 for enabling the overcurrent protection circuits 117, 118 to detect the overcurrent condition and render the FETs Q111, Q112 non-conductive. For example, the control circuit 120 may be configured to enable the overcurrent protection circuits 117, 118 during the conduction periods of each half-cycle.

The first overcurrent protection circuit 117 may receive (e.g., may be responsive to) the first gate control signal V_{GC1} generated by the first gate drive circuit 115, and the second overcurrent protection circuit 118 may receive (e.g., may be responsive to) the second gate control signal V_{GC2} generated by the second gate drive circuit 116. Since the first and second gate drive circuits 115, 116 generate the first and second gate control signals V_{GC1}, V_{GC2} using closed-loop control and the magnitudes of the first and second gate control signals V_{GC1}, V_{GC2} may indicate the magnitude of the load current I_{LOAD}, the first and second overcurrent protection circuit 117, 118 may be configured to determine an overcurrent condition in the load current I_{LOAD} (e.g., in the first FET Q111 and/or the second FET Q112) in response to the first and second gate control signals V_{GC1}, V_{GC2}, respectively. For example, the first overcurrent protection circuit 117 may be configured to detect the overcurrent condition by determining when the first gate control signal V_{GC1} indicates that the magnitude of the load current I_{LOAD} is at the first maximum current limit I_{LMT1} during the positive half-cycles. In addition, the second overcurrent protection circuit 118 may be configured to detect the overcurrent condition by determining when the second gate control signal V_{GC2} indicates that the magnitude of the load current I_{LOAD} is at the second maximum current limit I_{LMT2} during the negative half-cycles.

The first and second overcurrent protection circuits 117, 118 may be configured to control the first and second gate drive circuits 115, 116, respectively, to render the respective FETs Q111, Q112 non-conductive in response to detecting the overcurrent condition. The first and second gate drive circuits 115, 116 may be configured to render the respective FETs Q111, Q112 non-conductive by driving the magnitude of the first and second gate control signals V_{GC1}, V_{GC2}, respectively, to approximately zero volts. For example, the first gate drive circuit 115 may be configured to control the magnitude of the first gate control signals V_{GC1} to approximately zero volts by controlling the magnitude of the first target signal V_{TRGT1} of the first gate drive circuit 115 to approximately zero volts. In addition, the second gate drive circuit 116 may be configured to control the magnitude of the second gate control signals V_{GC1} to approximately zero volts by controlling the magnitude of the second target signal V_{TRGT2} of the second gate drive circuit 116 to approximately zero volts. While FIG. 1 shows the load regulation circuit 110 comprising the two different overcurrent protection circuits (e.g., the first and second overcurrent protection circuits 117, 118), the load regulation circuit 110 may also comprise a single overcurrent protection circuit that may be responsive to both the first gate control signals V_{GC1} and the second gate control signals V_{GC2}, and may be configured to control the first gate drive circuit 115 and the second gate drive circuit 116 in response to detecting an overcurrent condition.

The load control device 100 may include a user interface 132. The user interface 132 may include one or more actuators (e.g., buttons) for receiving user inputs and/or one or more visual indicators for providing user feedback. For example, the user interface 132 may include a toggle actuator and/or an intensity adjustment actuator (e.g., such as a slider control or a pair of raise and lower buttons) for controlling the lighting load 102. The control circuit 120 may be configured to control the load regulation circuit 110 to control the amount of power delivered to the lighting load 102 in response to actuations of the actuators of the user interface 132. In addition, the user interface 132 may also include one or more light sources, such as light-emitting diodes (LEDs), for illuminating the visual indicators, for example, to provide a visual indication of a status and/or the present intensity level L_{PRES} of the lighting load 102, and/or a visual indication of a selected preset. For example, the user interface 132 may comprise a vertically-oriented linear array of visual indicators. The control circuit 120 may be coupled to the light sources for illuminating the visual indicators of the user interface 132 to provide feedback.

The load control device 100 may comprise a communication circuit 134, e.g., such as a wired communication circuit or a wireless communication circuit. The communication circuit 134 may be communicatively coupled to the control circuit 120 for communicating (e.g., transmitting and receiving) messages (e.g., digital messages). The communication circuit 134 may be implemented as an external integrated circuit (IC) or as an internal circuit of the control circuit 120. For example, the communication circuit 134 may include a radio-frequency (RF) transceiver coupled to an antenna for transmitting and/or receiving RF signals. The communication circuit 330 may also include, for example, an RF transmitter for transmitting RF signals, an RF receiver for receiving RF signals, or an infrared (IR) transmitter and/or receiver for transmitting and/or receiving IR signals. The control circuit 120 may be configured to receive messages that include commands (e.g., control data) for controlling the lighting load 102 via the communication circuit 134. The control circuit 120 may be configured to transmit messages that include status information (e.g., feedback information) via the communication circuit 134.

The load control device 100 may include a memory 136. The memory 136 may be communicatively coupled to the control circuit 120 for the storage and/or retrieval of, for example, operational settings, such as, the present intensity level L_{PRES} of the lighting load 102. The memory 136 may be implemented as an external integrated circuit (IC) or as an internal circuit of the control circuit 120. The memory 136 may comprise a computer-readable storage media or machine-readable storage media that maintains computer-executable instructions for performing one or more procedure and/or functions as described herein. For example, the memory 136 may comprise computer-executable instructions or machine-readable instructions that when executed by the control circuit configure the control circuit to provide one or more portions of the procedures described herein. The control circuit 120 may access the instructions from memory 136 for being executed to cause the control circuit 120 to operate as described herein, or to operate one or more other devices as described herein. The memory 136 may comprise computer-executable instructions for executing configuration software. For example, the operational characteristics stored in the memory 136 may be configured during a configuration procedure of the load control device 100.

The load control device 100 may include a power supply 138. The power supply 140 may receive the AC mains line voltage V_{AC} and may generate one or more direct-current (DC) voltages for powering the circuitry of the load control device 100. For example, the power supply 140 may be configured to generate a first DC supply voltage, such as a FET supply voltage V_{FET-SUP} (e.g., approximately 12V) for powering the gate drive circuits 115, 116 to drive the respective FETs Q111, Q112. In addition, the power supply 140 may be configured to generate a second DC voltage, such as a supply voltage V_{CC} for powering the control circuit 120 and/or other low-voltage circuits of the load control device 100.

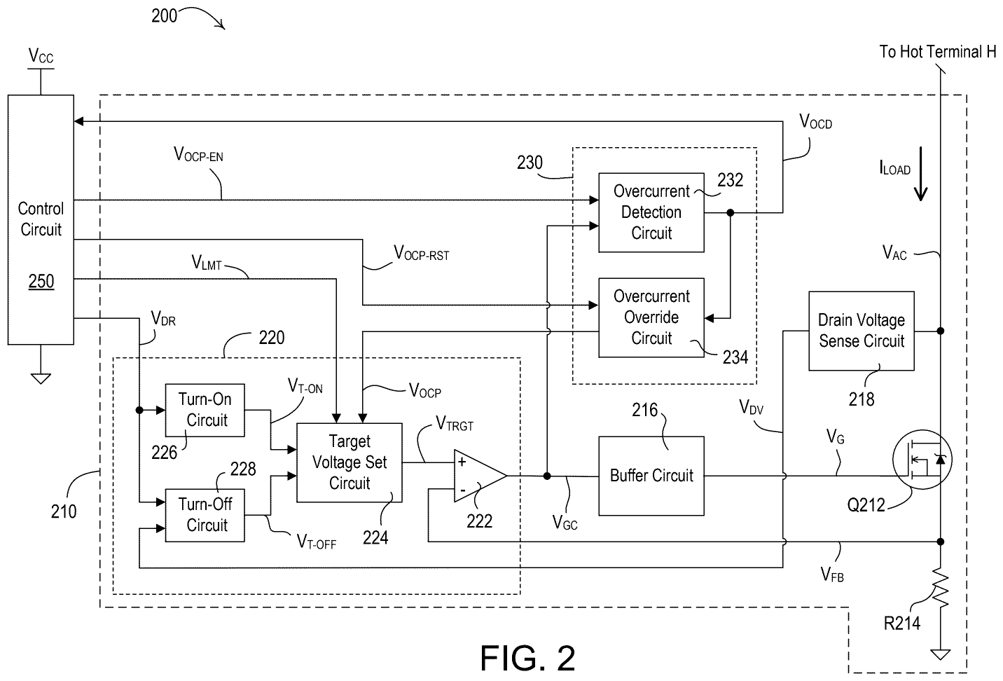

FIG. 2 is a block diagram of an example load regulation circuit 210 of a load control device 200, such as the load control device 100 shown in FIG. 1. The load regulation circuit 210 may comprise a field-effect transistor (FET) Q212, which may be coupled in series with a lighting load (e.g., the lighting load 102) for controlling a load current I_{LOAD} conducted through the lighting load and thus a present intensity level L_{PRES} of the lighting load. The load regulation circuit 210 shown in FIG. 2 may be an example of half of the load regulation circuit 110 shown in FIG. 1. For example, the FET Q212 may be an example of the FET Q111 and/or the FET Q212, and the circuitry of the load regulation circuit 210 shown in FIG. 2 may be duplicated for each of the FETs Q111, Q112 to implement the load regulation circuit 110 of FIG. 1 (e.g., with the FETs coupled in anti-series connection between a hot terminal H and a dimmed-hot terminal DH). The load regulation circuit 210 may be coupled to a hot terminal (e.g., the hot terminal H) of the load control device 200 for receiving an AC mains line voltage V_{AC}. For example, the load regulation circuit 210 may be coupled in series between the hot terminal of the load control device 200 and the lighting load (e.g., through a body diode of the additional FET in the load regulation circuit 210). In some examples, the load regulation circuit 210 may comprise a single FET (e.g., the FET Q212 as shown in FIG. 2) and the load regulation circuit 210 may be coupled inside of a full-wave bridge rectifier (e.g., with the full-wave bridge rectifier coupled between the hot terminal H and the dimmed-hot terminal DH, and circuit common coupled to the dimmed-hot terminal DH).

The load control device 200 may comprise a control circuit 250, e.g., a digital control circuit, for controlling the load regulation circuit 210 to conduct the load current I_{LOAD} through the lighting load to adjust the present intensity level L_{PRES} of the lighting load. For example, the control circuit 250 may be configured to adjust the present intensity level L_{PRES} of the lighting load between a high-end intensity level L_{HE} (e.g., approximately 100%) and a low-end intensity level L_{LE} (e.g., approximately 0.1-5%). The control circuit 250 may include one or more of a processor (e.g., a microprocessor), a microcontroller, a programmable logic device (PLD), a field programmable gate array (FPGA), an application specific integrated circuit (ASIC), or any suitable controller or processing device. The control circuit 250 may be configured to control the controllably conductive device of the load regulation circuit 210 to render the FET Q212 conductive and non-conductive using a phase-control dimming technique to generate a dimmed-hot voltage V_{DH} (e.g., a phase-control voltage) across the lighting load. During each half-cycle of the dimmed-hot voltage V_{DH}, the control circuit 250 may be configured to control the load regulation circuit 210, such that the FET Q212 may be non-conductive for a non-conduction period and conductive for a conduction period. In addition, the control circuit 250 may be configured to control the load regulation circuit 210 to control the FET Q212 between the non-conductive state and the conductive state during a transition period (e.g., a switching period) between the non-conduction period and the condition period.

The load regulation circuit 210 may comprise a feedback circuit, such as a sense resistor R214 (e.g., one of the resistors R113, R114) coupled in series with the FET Q212 for conducting the load current I_{LOAD}. In addition, the load regulation circuit 210 may comprise a gate drive circuit 220 (e.g., one of the gate drive circuits 115, 116) coupled to a gate of the FET Q212 for render the FET Q212 conductive and non-conductive. The control circuit 250 may control a drive signal V_{DR} (e.g., control the magnitude of the drive signal V_{DR} high or low) that may be received by the gate drive circuit 220 for controlling the FET Q212. The drive signal V_{DR1} may be provided to the gate drive circuit 220 for adjusting a control time of the dimmed-hot voltage V_{DH} generated across the lighting load and/or a magnitude of the load current I_{LOAD} conducted through the lighting load, for example, to control the present intensity level L_{PRES} of the lighting load. The control circuit 250 may be configured to adjust a duty cycle (e.g., an on time) of the drive signal V_{DR} to adjust the present intensity level L_{PRES} of the lighting load towards a target intensity level L_{TRGT}.

The gate drive circuit 220 may receive the drive signal V_{DR} from the control circuit 250 and control the FET Q212 in response to the drive signal V_{DR} to adjust the magnitude of the load current I_{LOAD} conducted through the lighting load. For example, the gate drive circuit 220 may generate a gate control signal V_{GC} for controlling the FET Q212 in response to the drive signal V_{DR}. The load regulation circuit 210 may include a buffer circuit 216 coupled in series between the gate drive circuit 220 and the gate of the FET Q212. The buffer circuit 216 may receive the control signal V_{GC} from the gate drive circuit 220 and may buffer the gate control signal V_{GC} to generate a gate voltage V_{G} at the gate of the FET Q212. The gate signal V_{G} may control conductivity of the FET Q212. For example, the gate signal V_{G}, via the gate control signal V_{GC}, may render the FET Q212 conductive and non-conductive. In some examples, the load regulation circuit 210 may not include the buffer circuit 216.

The gate drive circuit 220 may be configured to receive a feedback signal V_{FB} that may be generated by the sense resistor R214 (e.g., the feedback circuit). The feedback signal V_{FB} may have a magnitude that indicates the magnitude of the load current I_{LOAD} that flows through the FET Q212. For example, the magnitude of the feedback signal V_{FB} (e.g., the voltage generated across the sense resistor R214) may be proportional to the magnitude of the load current I_{LOAD}. The gate drive circuit 220 may be configured to generate the gate control signal V_{GC} in response to the feedback signal V_{FB} (e.g., using closed-loop control). Since the gate drive circuit 212 generates the gate control signal V_{GC} using closed-loop control, the magnitude of the gate control signal V_{GC} may indicate the magnitude of the load current I_{LOAD}. Further, in some examples, the control circuit 250 may receive the feedback signal V_{FB}, and the control circuit may be configured to determine the zero-crossing points of the load current I_{LOAD} conducted through the FET Q212) based on the feedback signal V_{FB} (e.g., since the magnitude of the load current I_{LOAD} is proportional to the magnitude of the feedback signal V_{FB} generated by the sense resistor R214).

To provide closed-loop control of the magnitude of the load current I_{LOAD}, the gate drive circuit 220 may comprise an operational amplifier circuit 222. The operational amplifier circuit 222 may have an inverting input configured to receive the feedback signal V_{FB} from the sense resistor R214. The operational amplifier circuit 222 may also have a non-inverting input configured to receive a target signal V_{TRGT} that may indicate a target magnitude I_{TRGT} towards which the magnitude of the load current I_{LOAD} may be controlled. The operational amplifier circuit 222 may generate the gate control signal V_{GC} at an output based on the target signal V_{TRGT} and the feedback signal V_{FB}. For example, the operational amplifier circuit 222 may adjust the gate control signal V_{GC} to control the FET Q212 and thus control the magnitude of the load current I_{LOAD} towards the target magnitude I_{TRGT} indicated by the magnitude of the target signal V_{TRGT}. The operational amplifier circuit 222 may be referenced to circuit common of the gate drive circuit 220 (e.g., to which the feedback signal V_{FB} is referenced). As previously mentioned, the magnitude of the feedback signal V_{FB} may be proportional to the magnitude of the load current I_{LOAD}. Accordingly, the operational amplifier circuit 222 may control the magnitude of the gate control signal V_{GC} in response to the magnitude of the load current I_{LOAD}. Some lighting loads, such as LED light sources, are capacitive loads, which may cause changes in a load voltage (e.g., a dimmed-hot voltage) across the lighting load that are not representative of the magnitude of the load current I_{LOAD} (e.g., proportional to the magnitude of the load current I_{LOAD}). Since both the sense resistor R214 and the operational amplifier circuit 222 are referenced to circuit common, the operational amplifier circuit 222 may be responsive to (e.g., only responsive to) the magnitude of the load current I_{LOAD} and not influenced by the magnitude of the load voltage across the lighting load.

The gate drive circuit 220 may comprise a target voltage set circuit 224, which may be configured to generate the target signal V_{TRGT} that is received by the operational amplifier circuit 222. The target voltage set circuit 224 of the gate drive circuit 220 may be configured to receive a limit signal V_{LMT}, which may be generated by the control circuit 250. The target voltage set circuit 224 may be configured to generate the target signal V_{TRGT} to control the FET Q212 during the conduction period of each half-cycle of the dimmed-hot voltage V_{DH} in response to the limit signal V_{LMT}. The target voltage set circuit 224 may be configured to set the magnitude of the target signal V_{TRGT} based on the limit signal V_{LMT} (e.g., a magnitude of the limit signal V_{LMT}). For example, the magnitude of the target signal V_{TRGT} of the first gate drive circuit 115 (e.g., based on the limit signal V_{LMT}) may set a maximum current limit I_{LMT} to which the gate control circuit 220 may control the magnitude of the load current I_{LOAD} during the conduction period of each half-cycle. For example, to control the magnitude of the maximum current limit I_{LMT} to two different respective magnitudes, the control circuit 250 may be configured to generate the limit signal V_{LMT} at two magnitudes, for example, a first magnitude, such as a lower limit (e.g., approximately circuit common or zero volts) and a second magnitude, such as an upper limit (e.g., approximately the supply voltage V_{CC}). For example, the control circuit 250 may be configured to adjust the magnitude of the limit signal V_{LMT} (e.g., to approximately circuit common) to adjust the magnitude of the target signal V_{TRGT} to a first limit-signal magnitude V_{MAG1} to adjust the maximum current limit I_{LMT} to a first limit magnitude I_{MAG1} (e.g., approximately 8 A). In addition, the control circuit 250 may be configured to adjust the magnitude of the limit signal V_{LMT} (e.g., to approximately the supply voltage V_{CC}) to adjust the magnitude of the target signal V_{TRGT} to a second limit-signal magnitude V_{MAG2} to adjust the maximum current limit I_{LMT} to a second limit magnitude I_{MAG2} (e.g., approximately 20 A). In some examples, the control circuit 250 may be configured to adjust the magnitude of the limit signal V_{LMT} to adjust the magnitude of the target signal V_{TRGT} between the first limit-signal magnitude V_{MAG1} and the second limit-signal magnitude V_{MAG2} to adjust the maximum current limit I_{LMT} between the first limit magnitude I_{MAG1} and the second limit magnitude I_{MAG2}. For example, the magnitude of the maximum current limit I_{LMT} may be proportional to the magnitude of the limit signal V_{LMT}. The control circuit 250 may comprise, for example, a digital-to-analog converter (DAC) for adjusting the magnitude of the limit signal V_{LMT}. In addition, the control circuit 250 may comprise, a filter circuit (e.g., a resistor-capacitor filter circuit) for generating the adjusting the magnitude of the limit signal V_{LMT} in response to a pulse-width modulated (PWM) signal.

The gate drive circuit 220 may also comprise a turn-on circuit 226 and a turn-off circuit 228 for controlling the generation of the target signal V_{TRGT} during the transition period between the non-conduction period and the conduction period of each half-cycle (e.g., depending on whether the control circuit 250 is using the forward phase-control dimming technique or the reverse phase-control dimming technique). When the forward phase-control dimming technique is used, the target voltage set circuit 224 may be configured to generate the target signal V_{TRGT} during the transition period based on a turn-on signal V_{T-ON} generated by the turn-on circuit 226. The turn-on circuit 226 may be configured to receive the drive voltage V_{DR} from the control circuit 250 and generate the turn-on signal V_{T-ON}. When the forward phase-control dimming technique is used, the target voltage set circuit 224 may generate the target signal V_{TRGT} based on the turn-on signal V_{T-ON} during the transition period and then based on the limit signal V_{LMT} during the conduction period.

The turn-on circuit 226 may be configured to start generating the turn-on signal V_{T-ON} (e.g., control the magnitude of the turn-on signal V_{T-ON} above approximately zero volts) in response to the control circuit 250 controlling the drive signal V_{DR} to render the FET Q212 conductive at the control time during the half-cycle (e.g., in response to the magnitude of the drive signal V_{DR} going high at the control time during each half-cycle). For example, the target voltage set circuit 224 may be configured to control the magnitude of the target signal V_{TRGT} to be approximately equal to the magnitude of the turn-on signal V_{T-ON} during the transition period. In some examples, the turn-on circuit 226 may generate the turn-on signal V_{T-ON} to cause the target signal V_{TRGT} to have, for example, a linear or exponential shape during the transition period. In other examples, the turn-on circuit 226 may generate the target signal V_{TRGT} to be shaped (e.g., having a magnitude that adjusts with respect to time over the transition period) based on the drive signal V_{DR} (e.g., starting when the magnitude of the drive signal V_{DR} goes high). During the transition period in the positive half-cycles, the gate drive circuit 220 may control the FET Q212 in the linear region to adjust an impedance (e.g., a drain-source impedance) of the FET Q212 based on the gate control signal V_{GC}. The gate drive circuit 220 may control the FET Q212 to adjust the impedance of the FET Q212 in response to the feedback signal V_{FB} to control the magnitude of the load current I_{LOAD} towards the target magnitude I_{TRGT} indicated by the target signal V_{TRGT}, such that a shape of the load current I_{LOAD} follows the shape of the target signal V_{TRGT} (e.g., the shape of the turn-on signal V_{T-ON}) during most or all of the transition period.

When the reverse phase-control dimming technique is used, the target voltage set circuit 224 may be configured to generate the target signal V_{TRGT} during the transition period based on a turn-off signal V_{T-OFF} generated by the turn-off circuit 228. The turn-off circuit 228 may be configured to receive the drive voltage V_{DR} from the control circuit 250 and generate the turn-off signal V_{T-OFF}. In addition, the turn-off circuit 228 may be configured to receive a drain-voltage signal V_{DV} (e.g., a second feedback signal) from a drain voltage sense circuit 218, which may be coupled to the FET Q212 (e.g., to a drain of the FET Q212). The drain voltage sense circuit 218 may detect a magnitude of a voltage developed across the FET Q212 and may generate the drain-voltage signal V_{DV}, such that a magnitude of the drain voltage signal V_{DV} indicates the magnitude of the voltage across the FET Q212. When the reverse phase-control dimming technique is used, the target voltage set circuit 224 may generate the target signal V_{TRGT} based on the limit signal V_{LMT} during the conduction period, and the turn-off signal V_{T-ON} and the drain voltage signal V_{DV} during the transition period.

The turn-off circuit 228 may be configured to start shaping the turn-off signal V_{T-OFF} (e.g., to begin controlling the magnitude of the turn-off signal V_{T-OFF} towards zero volts) in response to the control circuit 250 controlling the drive signal V_{DR} to render the FET Q212 non-conductive at the control time during the half-cycle (e.g., in response to the magnitude of the drive signal V_{DR} going low at the control time and further in response to the drain-voltage signal V_{DV}). For example, the target voltage set circuit 224 may be configured to control the magnitude of the target signal V_{TRGT} to be approximately equal to the magnitude of the turn-off signal V_{T-OFF} during the transition period. In some examples, the turn-off circuit 228 may generate the turn-off signal V_{T-OFF} to cause the target signal V_{TRGT} to have, for example, a linear or exponential shape during the transition period. In other examples, the turn-off circuit 228 may generate the target signal V_{TRGT} to be shaped (e.g., having a magnitude that adjusts with respect to time over the transition period) based on the drive signal V_{DR} and/or the drain-voltage signal V_{DV}. During the transition period in the negative half-cycles, the gate drive circuit 220 may control the FET Q212 in the linear region to adjust the impedance (e.g., the drain-source impedance) of the FET Q212 based on the gate control signal V_{GC}. The gate drive circuit 220 may control the FET Q212 to adjust the impedance of the FET Q212 in response to the feedback signal V_{FB} to control the magnitude of the load current I_{LOAD} towards the target magnitude I_{TRGT} indicated by the target signal V_{TRGT}, such that the shape of the load current I_{LOAD} follows the shape of the target signal V_{TRGT} (e.g., the shape of the turn-off signal V_{T-OFF}) during most or all of the transition period.

The target voltage set circuit 224 may generate the target signal V_{TRGT} based on the limit signal V_{LMT} from the control circuit 250, the turn-on signal V_{T-ON} from the turn-on circuit 226 (e.g., in response to the drive signal V_{DR}), and/or the turn-off signal V_{T-OFF} from the turn-off circuit 228 (e.g., in response to the drive signal V_{DR}). For example, the target voltage set circuit 224 may act as a combining circuit and combine one or more of the limit signal V_{LMT}, the turn-on signal V_{T-ON}, and/or the turn-off signal V_{T-OFF} to generate the target signal V_{TRGT}. The gate drive circuit 220 (e.g., the operational amplifier circuit 222) may generate the gate control signal V_{GC} in response to the target signal V_{TRGT} and the feedback signal V_{FB}. During the condition period of each-half cycle, the gate drive circuit 220 may control the FET Q212 in the saturation region based on the gate control signal V_{GC}.

The gate drive circuit 220 of the load regulation circuit 210 may be configured to provide overcurrent protection (e.g., inherent overcurrent protection and/or current-limiting protection) for the load control device 200. In some examples, the gate drive circuit 220 may be configured to limit the magnitude of the load current I_{LOAD} conducted through the FET Q212 in response to the gate control signal V_{GC}. For example, when the FET Q212 is conductive, the gate drive circuit 220 may be configured to limit the magnitude of the load current I_{LOAD} conducted through the FET Q212 to the maximum current limit I_{LMT} as indicated by the limit signal V_{LMT}. When the magnitude of the load current I_{LOAD} conducted through the FET Q212 is at the maximum current limit I_{LMT}, the FET Q212 may operate in the linear region.

The load regulation circuit 210 may also include an overcurrent protection (OCP) circuit 230 (e.g., the overcurrent protection circuits 117, 118). The overcurrent protection circuit 230 may comprise an overcurrent detection circuit 232 and an overcurrent override circuit 234. The overcurrent detection circuit 232 may be configured to detect the overcurrent condition, and generate an overcurrent detection signal V_{OCD} that indicates the overcurrent condition. The overcurrent detection circuit 232 of the overcurrent protection circuit 230 may receive (e.g., may be responsive to) the gate control signal V_{GC} generated by the gate drive circuit 220. Since the gate drive circuit 220 generates the gate control signal V_{GC1} using closed-loop control and the magnitude of the gate control signal V_{GC} indicates the magnitude of the load current I_{LOAD}, the overcurrent detection circuit 232 may be configured to detect the overcurrent condition in the load current I_{LOAD} (e.g., in the FET Q212) in response to the gate control signal V_{GC}. For example, the first gate drive circuit 115 may be configured to detect the overcurrent condition by determining when the gate control signal V_{GC} indicates that the magnitude of the load current I_{LOAD} is at the maximum current limit I_{LMT}.

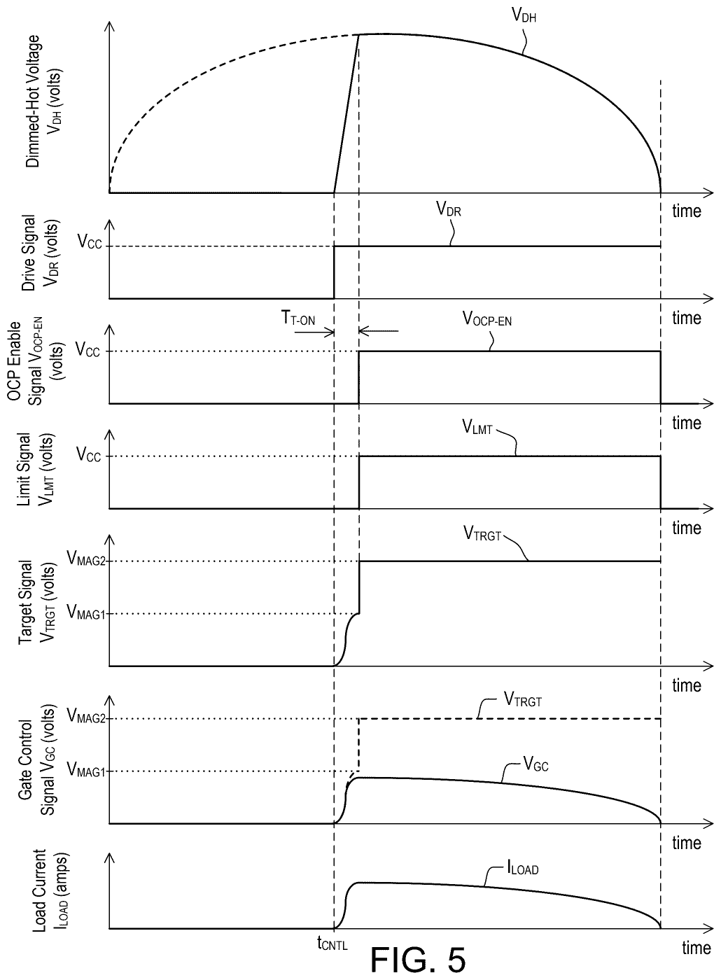

The overcurrent detection circuit 232 may be configured to receive an overcurrent protection (OCP) enable signal V_{OCP-EN} from the control circuit 250 for enabling and disabling the overcurrent protection circuit 230. The overcurrent detection circuit 232 may be configured to control the overcurrent detection signal V_{OCD} to indicate the overcurrent condition when the overcurrent protection circuit 230 is enabled (e.g., in response to the overcurrent protection enable signal V_{OCP-EN}). The overcurrent detection circuit 232 may be configured to control the overcurrent detection signal V_{OCD} to indicate the overcurrent condition after a trip time period T_{TRIP} from when the overcurrent condition is first detected. The control circuit 250 may be configured to enable the overcurrent protection circuit 230 during the conduction periods of each half-cycle (e.g., as shown in FIGS. 5 and 7-10). For example, when operating using a forward phase-control technique, the control circuit 250 may generate the OCP enable signal V_{OCP-EN} (e.g., drive the OCP enable signal V_{OCP-EN} high toward the supply voltage V_{CC}) after a time delay from the control time t_{CNTL}. For instance, the control circuit 250 may generate the OCP enable signal V_{OCP-EN} after a turn-on time period T_{T-ON} (e.g., approximately 50 microseconds) from the control time t_{CNTL}. The control circuit may drive the OCP enable signal V_{OCP-EN} low (e.g., toward circuit common) at the next zero-crossing event. As such, the control circuit 250 may be configured to enable the overcurrent protection circuit 230 during the conduction periods of each half-cycle.

The overcurrent override circuit 234 may be configured to receive the overcurrent detection signal V_{OCD} from the overcurrent detection circuit 232, and generate an overcurrent protection signal V_{OCP} for rendering the FET Q212 non-conductive after the overcurrent detection signal V_{OCD} controls the overcurrent detection signal V_{OCD} to indicate the overcurrent condition. The overcurrent override circuit 234 may be configured to control the gate drive circuit 220 to render the FET Q212 non-conductive in response to the overcurrent detection signal V_{OCD} controlling the overcurrent detection signal V_{OCD} to indicate the overcurrent condition. The gate drive circuit 220 may be configured to render the FET Q212 non-conductive in response to the overcurrent protection signal V_{OCP} by driving the magnitude of the gate control signal V_{GC} to approximately zero volts. For example, the target voltage set circuit 224 may be configured to receive the overcurrent protection signal V_{OCP} and to control the magnitude of the target signal V_{TRGT} of the first gate drive circuit 115 to approximately zero volts to control the magnitude of the gate control signal V_{GC} to approximately zero volts.

The overcurrent override circuit 234 may be configured to render the FET Q212 non-conductive after the trip time period T_{TRIP} from when the overcurrent detection circuit 232 first detects the overcurrent condition. The overcurrent override circuit 234 may be configured to latch the FET Q212 in the non-conductive state for the remainder of the present half-cycle in response to detecting the overcurrent condition. The overcurrent override circuit 234 may be configured to receive an overcurrent protection reset signal V_{OCP-RST}, which may be generated by the control circuit 250. The overcurrent override circuit 234 may be configured, in response to the overcurrent protection reset signal V_{OCP-RST}, to unlatch the FET Q212 from the non-conductive state to allow the FET Q212 to be rendered conductive again in response to the gate control signal V_{GC}. For example, the control circuit 250 may be configured to control the overcurrent protection reset signal V_{OCP-RST} to unlatch the FET Q212 from the non-conductive state at the end of each half-cycle.

The control circuit 250 may be configured to receive the overcurrent detection signal V_{OCD} from the overcurrent detection circuit 232, and to provide overcurrent protection (e.g., redundant overcurrent protection) for the load control device 200 in response to the overcurrent detection signal V_{OCD}. For example, the control circuit 250 may be configured to control the drive signal V_{DR} to render the FETs Q212 non-conductive when the overcurrent detection signal V_{OCD} indicates an overcurrent condition. If the overcurrent condition persists repeatedly (e.g., for a number of half-cycles, such as 10 half-cycles in a row), the control circuit 250 may be configured to render the FET Q212 to turn off the lighting load for a period of time (e.g., a few seconds), and then attempt to turn the lighting load back on.

When using the forward phase-control dimming technique, the control circuit 250 may control the drive signal V_{DR} to render the FET Q212 non-conductive (e.g., control the magnitude of the drive signal V_{DR} low towards circuit common) at the beginning of the half-cycle. In addition, the control circuit 250 may control the overcurrent protection enable signal V_{OCP-EN} to disable the overcurrent protection circuit 230 during the non-conduction period of the half-cycle. At the control time during the half-cycle, the control circuit 250 may be configured to control the drive signal V_{DR} to render the FET Q212 conductive (e.g., control the magnitude of the drive signal V_{DC} high towards the supply voltage V_{CC}) to generate an edge (e.g., a rising edge) in the drive signal V_{DR}. In response to the edge in the drive signal V_{DR}, the target voltage set circuit 224 may set the target voltage V_{TRGT} to be equal to the turn-on signal V_{T-ON} during the transition period of the half-cycle. As noted above, the turn-on signal V_{T-ON} may be shaped. At the beginning of the conduction period (e.g., at the end of the transition period), the control circuit 250 may be configured to control the overcurrent protection enable signal V_{OCP-EN} to enable the overcurrent protection circuit 230 and control the limit signal V_{LMT} to set the magnitude of the maximum current limit I_{LMT} to which the gate control circuit 220 may control the magnitude of the load current I_{LOAD} during the conduction period of the half-cycle.

When using the reverse phase-control dimming technique, the control circuit 250 may control the drive signal V_{DR} to render the FET Q212 conductive (e.g., control the magnitude of the drive signal V_{DR} high towards the supply voltage V_{CC}) at the beginning of the half-cycle. In some examples, the control circuit 250 may already be driving the magnitude of the drive signal V_{DR} high towards the supply voltage V_{CC} at the beginning of the half-cycle, so the control circuit 250 may simply maintain the magnitude of the drive signal V_{DR} to render the FET Q212 conductive at the beginning of the half-cycle. In addition, the control circuit 250 may control the overcurrent protection enable signal V_{OCP-EN} to enable the overcurrent protection circuit 230 and control the limit signal V_{LMT} to set the magnitude of the maximum current limit I_{LMT} to which the gate control circuit 220 may control the magnitude of the load current I_{LOAD} during the conduction period of the half-cycle. At the control time during the half-cycle, the control circuit 250 may be configured to control the drive signal V_{DR} to render the FET Q212 non-conductive (e.g., control the magnitude of the drive signal V_{DC} low towards circuit common) to generate an edge (e.g., a falling edge) in the drive signal V_{DR}. At the end of the conduction period (e.g., at the beginning of the transition period), the control circuit 250 may be configured to control the overcurrent protection enable signal V_{OCP-EN} to disable the overcurrent protection circuit 230.

In response to the edge of the drive signal V_{DR}, the gate drive circuit 220 may be configured to decrease (e.g., start decreasing) the magnitude of the target voltage V_{TRGT} with respect to time. For example, the turn-off circuit 228 may set the magnitude of the turn-off signal V_{T-OFF} to a predetermined value, e.g., approximately circuit common, to set the magnitude of the maximum current limit I_{LMT} at the first limit magnitude I_{MAGI} (e.g., approximately 8 A). Thereafter, the turn-off circuit 228 may gradually decrease the magnitude of the turn-off signal V_{T-OFF} until the drain voltage signal V_{DV} from the drain voltage sense circuit 218 indicates that the voltage across the FET Q212 is starting to rise (e.g., has exceeding a drain voltage threshold V_{TH} indicating that the FET is starting to become non-conductive). Once the magnitude of the voltage developed across the FET Q212 (e.g., as indicated by the drain voltage signal V_{DV}) exceeds the drain voltage threshold V_{TH}, the turn-off circuit 228 may begin to shape the turn-off signal V_{T-OFF} from the present magnitude (e.g., the magnitude at the time the drain voltage signal V_{DV} indicates that the magnitude of the voltage across the FET Q212 has exceeded the drain voltage threshold V_{TH}) to zero volts. The target voltage set circuit 224 may set the target voltage V_{TRGT} to be equal to the turn-off signal V_{T-OFF} during the rest of the transition period of the half-cycle.

The load control device 200 may be configured to use the reverse phase-control dimming technique to control a capacitive load. A capacitive load may be characterized by a large capacitance that needs to be charged when turning on the capacitive load and/or during normal operation as the capacitance discharges. The capacitance of a capacitive load may need to draw a rather large charging current through the load control device 200 to charge the capacitance when first turning on the capacitive load and/or to recharge the capacitance during each half-cycle. When using the reverse phase-control dimming technique, the control circuit 250 may be configured to control the limit signal V_{LMT} to adjust the magnitude of the target signal V_{TRGT} to the second limit-signal magnitude V_{MAG2} (e.g., for the length of the conduction period) to set the magnitude of the maximum current limit I_{LMT} at a larger magnitude, such as the second limit magnitude I_{MAG2} (e.g., approximately 20 A), to allow the FET Q212 to appropriately conduct the charging current of the capacitive load. Since the charging current may only last for a short amount of time, the conduction of the charging current may not damage the FET Q212 and the overcurrent protection circuit 230 may not need to render the FET Q212 non-conductive to protect the FET Q212.

In addition, the load control device 200 may be configured to use the forward phase-control dimming technique to control an inductive load. Some inductive loads may saturate when an asymmetrical current having a direct-current (DC) component is conducted through the inductive load. For example, an inductive load may be susceptible to overheating and/or damage when the inductive load conducts an asymmetrical current having a large peak magnitude above a saturation threshold in at least one of the half-cycles. In some instances, the saturation threshold may be less than the maximum current limit I_{LMT} of the over-current protection circuit 230. Accordingly, when using the forward phase-control dimming technique, the control circuit 250 may be configured to control the limit signal V_{LMT} to adjust the magnitude of the target signal V_{TRGT} to the first limit-signal magnitude V_{MAG1} to set the magnitude of the maximum current limit I_{LMT} at a smaller magnitude, such as the first limit magnitude I_{MAG1} (e.g., approximately 8 A), to allow the overcurrent protection circuit 230 to appropriately protect the inductive loads from large load currents. The first limit magnitude I_{MAG1} may be smaller than second limit magnitude I_{MAG2}, which for example, may prevent an inductive load from saturating and/or overheating when using the forward phase-control technique.

However, in some examples, the load control device 200 may be configured to use the forward phase-control dimming technique to control a capacitive load. When the FET Q212 is rendered conductive each half-cycle at the control time (e.g., the firing time), the capacitive load may be configured to conduct a large, but short spike of charging current to charge the capacitance of the capacitive load. If the capacitive load is unable to conduct the large spike of charging current, the capacitive load may not function properly during normal operation (e.g., the capacitive load will not be able to establish an internal power supply or bus voltage to run its electrical components, and/or the FET Q212 may operate in the linear region and block the charging current). However, the magnitude of the spike of charging current may exceed the maximum current limit I_{LMT}, which may be set at the first limit magnitude I_{MAG1} when using the forward phase-control dimming technique (e.g., to accommodate inductive loads). As a result, the capacitive load may not be able to appropriately draw the charging current through the FET Q212, and the capacitance of the capacitive load may take longer to charge, which could cause flickering and/or unwanted adjustments in the present intensity level L_{PRES} of the lighting load.

Accordingly, in some examples, when using the forward phase-control dimming technique, the control circuit 250 may be configured to increase the magnitude of the maximum current limit I_{LMT} for a brief period of time following (e.g., immediately following) the control time (e.g., the firing time) before adjusting the maximum current limit I_{LMT} to a smaller magnitude during the rest of the conduction period of the half-cycle. For example, the control circuit 250 may be configured to adjust the maximum current limit I_{LMT} to the second limit magnitude I_{MAG2} for a pulse period T_{PULSE} that starts at the charging time and then adjust the maximum current limit I_{LMT} to the first limit magnitude I_{MAG1} during the rest of the conduction period of the half-cycle. For example, the control circuit 250 may set a length of the pulse period T_{PULSE} to a first time period T_{P1} (e.g., approximately 500 μsec) to allow the capacitance of the capacitive load to appropriately charge each half-cycle.

In some examples, the load control device 200 may be configured to use the forward phase-control dimming technique to control an incandescent lamp (e.g., a resistive load). Incandescent lamps may have a low resistance when not energized (e.g., off) and thus cold. The resistance of the incandescent lamp may increase after being energized (e.g., and thus warm) for a period of time. Because of the low resistance when cold, an incandescent lamp may draw more current (e.g., an inrush current) when first turned on than after the incandescent lamp has been energized for the period of time. The magnitude of the inrush current conducted by the incandescent lamp when first turn on may exceed the first limit magnitude I_{MAG1} of the maximum current limit I_{LMT}, and as such, the incandescent load may not be able to appropriately conduct the inrush current if the maximum current limit I_{LMT} is set to first limit magnitude I_{MAG1}. This may cause the incandescent lamp to take longer to warm up, which may cause the present intensity level L_{PRES} of the incandescent lamp to take longer to get to the appropriate level-even with the increased magnitude of the maximum current limit I_{LMT} (e.g., the second limit magnitude I_{MAG2}) during the pulse period T_{PULSE} (e.g., as set at the first period length T_{P1}). Accordingly, when turning on the lighting load, the control circuit 250 may be configured to increase (e.g., temporarily increase) the length of the pulse period T_{PULSE} for a period of time to allow the incandescent lamp to conduct the inrush current. For example, when turning on the lighting load, the control circuit 250 may be configured to increase the length of the pulse period T_{PULSE} to a second time period T_{P2} (e.g., approximately 2,000 μsec) for a number of half-cycles (e.g., approximately 120 half-cycles) before reverting back to the first time period T_{P1}.

In some examples, when using the forward phase-control dimming technique, the control circuit 250 may be configured to increase the magnitude of the maximum current limit I_{LMT} to a constant magnitude for a brief period of time following (e.g., immediately following) the control time (e.g., the firing time) before reducing the magnitude of the maximum current limit I_{LMT} with respect to time and then maintaining the maximum current limit I_{LMT} to a smaller magnitude during the rest of the conduction period of the half-cycle. For example, the control circuit 250 may be configured to adjust the maximum current limit I_{LMT} to the second limit magnitude I_{MAG2} for the first time period T_{P1} and then reducing (e.g., linearly reducing) the magnitude of the maximum current limit I_{LMT} from the second limit magnitude I_{MAG2} to the first limit magnitude I_{MAG1} across an adjustment period T_{ADJ} before maintaining the maximum current limit I_{LMT} to the first limit magnitude I_{MAG1} for the remainder of the half-cycle.

Further, in some examples, when using the forward phase-control dimming technique, the control circuit 250 may be configured to increase the magnitude of the maximum current limit I_{LMT} over time during a ramp-up period T_{R-UP} until the maximum current limit I_{LMT} reaches the second limit magnitude I_{MAG2} following (e.g., immediately following) the control time (e.g., the firing time), maintain the maximum current limit I_{LMT} at the second limit magnitude I_{MAG2} for a period of time (e.g., the pulse period T_{PULSE}), and reduce the magnitude of the maximum current limit I_{LMT} with respect to time over a ramp-down period T_{R-DOWN} until the maximum current limit I_{LMT} reaches the second limit magnitude I_{MAG1} (e.g., and then maintain the maximum current limit I_{LMT} at the second limit magnitude I_{MAG1} for the rest of the conduction period of the half-cycle). The control circuit 250 may adjust the maximum current limit I_{LMT} over the ramp-up and/or ramp-down periods using a linear adjustment, a step-wise adjustment, or other shapes.

In addition, the control circuit 250 may be configured to determine whether the load control device 200 is connected to an inductive load, and adjust the magnitude of the maximum current limit I_{LMT} when the load control device 200 is connected to an inductive load. For example, the control circuit 250 may be configured to determine that the load control device 200 is connected to an inductive load if the magnitude of the load current I_{LOAD} conducted through the FET Q212 (e.g., as indicated by the feedback signal V_{FB}) is out of phase with the AC mains line voltage V_{AC} (e.g., if zero-crossings of the load current I_{LOAD} as indicated by the feedback signal V_{FB} do not line up with zero-crossings of the AC mains line voltage V_{AC} as indicated by the zero-cross signal V_{ZC}). When the control circuit 250 determines that the load control device 200 is connected to an inductive load, the control circuit 250 may control the limit signal V_{LMT} to set the magnitude of the maximum current limit I_{LMT} at the first limit magnitude I_{MAG1} while using the forward phase-control dimming technique. In some example, when the control circuit 250 determines that the load control device 200 is connected to an inductive load, the control circuit 250 may control the limit signal V_{LMT} to set the magnitude of the maximum current limit I_{LMT} at the second limit magnitude I_{MAG2} for the pulse period T_{PULSE} and then set the magnitude of the maximum current limit I_{LMT} to the first limit magnitude I_{MAG1} during the rest of the conduction period of the half-cycle while using the forward phase-control dimming technique.

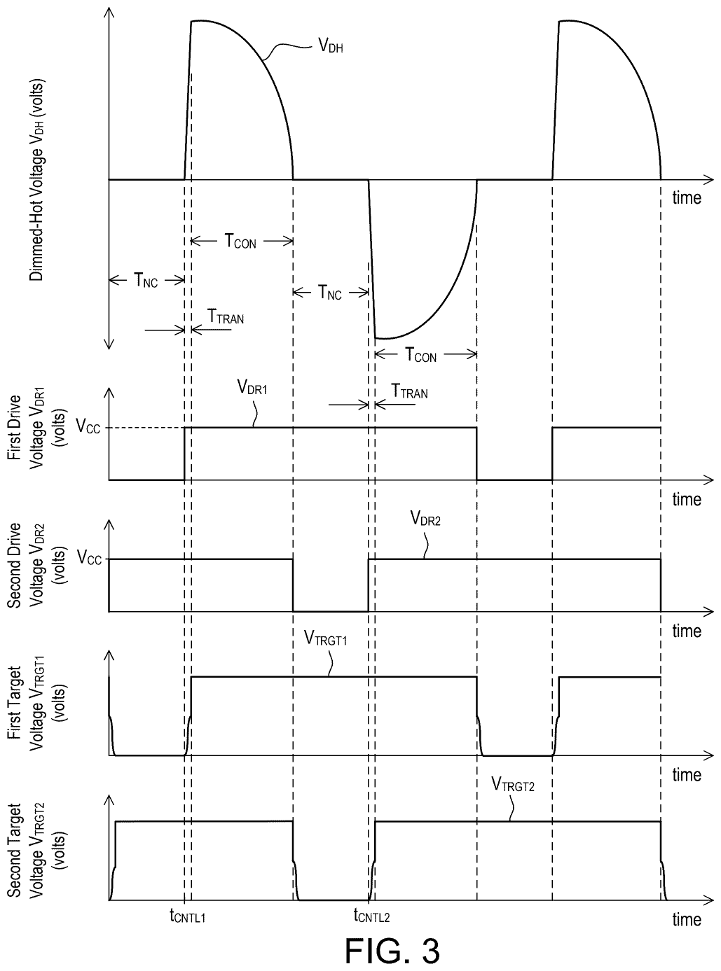

FIG. 3 shows examples of waveforms that illustrate an operation of a load control device (e.g., the load control device 100 shown in FIG. 1 and/or the load control device 200 shown in FIG. 2) using a forward phase-control dimming technique. As described herein, the load control device may receive an alternating-current (AC) main line voltage from an AC power source and may generate a dimmed-hot voltage V_{DH} at a dimmed-hot terminal of the load control device for controlling a lighting load. Using the forward phase-control dimming technique as shown in FIG. 3, a control circuit (e.g., the control circuit 120 and/or the control circuit 250) may render a controllably conductive device non-conductive at the beginning of each half-cycle during a non-conduction period T_{NC}, render the controllably conductive device conductive at a control time (e.g., a firing time) during the half-cycle, and maintain the controllably conductive device conductive during a conduction period T_{CON} until the end of the half-cycle. The control circuit may control the controllably conductive device between the non-conductive state and the conductive state during a transition time T_{TRAN} during each half-cycle. For example, the controllably conductive device may comprise two semiconductor switches, such as two FETs in anti-series connection (e.g., as shown in FIG. 1). Further, it should be appreciated that the slope of the dimmed-hot voltage V_{DH} when transitioning from and to zero volts as shown in FIGS. 3-10 is exaggerated for illustrated purposes. The control circuit may generate one or more drive signals for controlling the conductivity of the controllably conductive device. For example, the control circuit may generate a first drive signal V_{DR1} to render a first semiconductor switch (e.g., the first FET Q111 of the load regulation circuit 110) conductive during the positive half-cycles, and may generate a second drive signal V_{DR2} to render a second semiconductor switch (e.g., the second FET Q112 of the load regulation circuit 110) conductive during the negative half-cycles. For example, the first and second drive signals V_{DR1}, V_{DR2} may be pulse-width modulated signals.

The load control device may generate target signals (e.g., a first target signal V_{TRGT1} and a second target signal V_{TRGT2}) for controlling a load current conducted through the lighting load. For example, as described herein, a first gate drive circuit of the load control device (e.g., the first gate drive circuit 115 and/or the gate drive circuit 220) may receive the first drive signal V_{DR1}, which may be driven high at a control time t_{CTNL1} (e.g., a firing time) during each of the positive half-cycles of the AC main line voltage. The first gate drive circuit may start to shape the first target signal V_{TRGT1} in response to the first drive signal V_{DR1}, and may shape the first target signal V_{TRGT1} during a turn-on time period (e.g., during the transition period T_{TRAN}). The first gate drive circuit may use the first target signal V_{TRGT1} to render the first semiconductor switch conductive and maintain the first semiconductor switch conductive during the remainder of the positive half-cycle (e.g., during the conduction period T_{CON}). Similarly, a second gate drive circuit of the load control device (e.g., the second gate drive circuit 116 and/or the gate drive circuit 220) may receive the second drive signal V_{DR2}, which may be driven high at a control time t_{CNTL2} (e.g., a firing time) during each of the negative half-cycles of the AC main line voltage. The second gate drive circuit may shape the second target signal V_{TRGT2} in response to the second drive signal V_{DR2}, and may shape the second target signal V_{TRGT2} during a turn-on time period (e.g., during the transition time T_{TRAN}). The second gate drive circuit may use the second target signal V_{TRGT2} to render the second semiconductor switch conductive and maintain the second semiconductor switch conductive during the remainder of the negative half-cycle.

At the end of each of the negative half-cycles of the AC main line voltage (e.g., near a zero-crossing of the AC main line voltage), the first drive signal V_{DR1} may be driven low by the control circuit, and the first gate drive circuit may shape the first target signal V_{TRGT1} during a turn-off time period. Similarly, at the end of each of the positive half-cycles of the AC main line voltage (e.g., near a zero-crossing of the AC main line voltage), the second drive signal V_{DR2} may be driven low by the control circuit, and the second gate drive circuit may shape the second target signal V_{TRGT2} during a turn-off time period. Accordingly, the first and second target signals V_{TRGT1}, V_{TRGT2} may be shaped on their rising and falling edges. Alternatively, the first and second target signals V_{TRGT1}, V_{TRGT2} may only be shaped on their rising edges and not their falling edges when using the forward phase-control dimming technique.

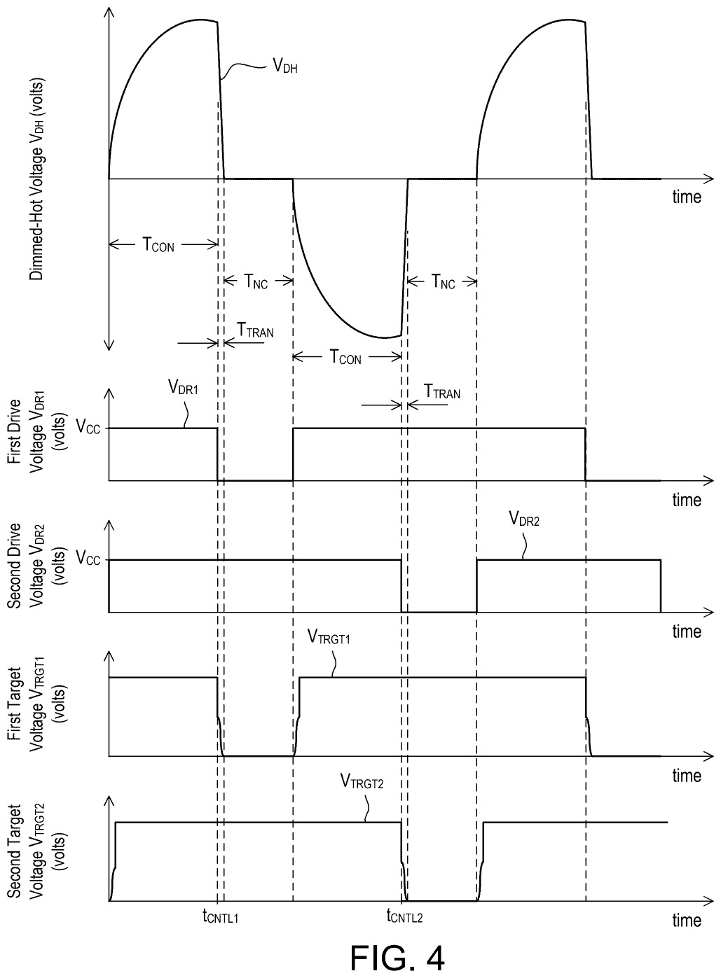

FIG. 4 shows examples of waveforms that illustrate an operation of a load control device (e.g., the load control device 100 shown in FIG. 1 and/or the load control device 200 shown in FIG. 2) using a reverse phase-control dimming technique. Similar to the operation of the load control device with a forward phase-control dimming technique described herein, the load control device may receive an AC mains line voltage from an AC power source and may generate a dimmed-hot voltage V_{DH} at a dimmed-hot terminal of the load control device for controlling a lighting load. Using the reverse phase-control dimming technique as shown in FIG. 4, a control circuit may render a controllably conductive device conductive at the beginning of each half-cycle during a conduction period T_{CON}, render the controllably conductive device non-conductive at a control time (e.g., a firing time) during the half-cycle, and maintain the controllably conductive device conductive during a non-conduction period T_{NC} until the end of the half-cycle. The control circuit may control the controllably conductive device between the non-conductive state and the conductive state during a transition time T_{TRAN} during each half-cycle. For example, the controllably conductive device may comprise two semiconductor switches, such as two FETs in anti-series connection. The control circuit may generate one or more drive signals for controlling the conductivity of the controllably conductive device. For example, the control circuit may generate a first drive signal V_{DR1} to render a first semiconductor switch (e.g., the first FET Q111 of the load regulation circuit 110) conductive during the positive half-cycles. The control circuit may generate a second drive signal V_{DR2} to render a second semiconductor switch (e.g., the second FET Q112 of the load regulation circuit 110) conductive during the negative half-cycles. For example, the first and second drive signals V_{DR1}, V_{DR2} may be pulse-width modulated signals.

The load control device may generate target signals (e.g., a first target signal V_{TRGT1} and a second target signal V_{TRGT2}) for controlling a load current conducted through the lighting load. For example, as described herein, a first gate drive circuit of the load control device (e.g., the first gate drive circuit 115 and/or the gate drive circuit 220) may receive the first drive signal V_{DR1}, which may be high at the beginning of each of the positive half-cycles, such that the controllably conductive device is rendered conductive at the beginning of each of the positive half-cycles. The first drive signal V_{DR-1a} may be driven low at a control time t_{CNTL1} (e.g., a firing time) during each of the positive half-cycles of the AC mains line voltage. The first gate drive circuit may begin to shape the first target signal V_{TRGT-1a} in response to the first drive signal V_{DR1}, and may shape the first target signal V_{TRGT1} during a turn-off time period (e.g., during the transition period T_{TRAN}). The first gate drive circuit may use the first target signal V_{TRGT1} to render the first semiconductor switch non-conductive and maintain the first semiconductor switch conductive during the remainder of the positive half-cycle (e.g., during the non-conduction period T_{NC}). Similarly, a second gate drive circuit of the load control device (e.g., the second gate drive circuit 116 and/or the gate drive circuit 220) may receive the second drive signal V_{DR2}, which may be high at the beginning of each of the negative half-cycles, such that the controllably conductive device is rendered conductive at the beginning of each of the negative half-cycles. The second drive signal V_{DR2} may be driven low at a control time t_{CNTL2} (e.g., a firing time) during each of the negative half-cycles of the AC mains line voltage. The load control device may begin to shape the second target signal V_{TRGT2} in response to the second drive signal V_{DR2}, and may shape the second target signal V_{TRGT2} during a turn-off time period (e.g., during the transition period T_{TRAN}). The second gate drive circuit may use the second target signal V_{TRGT2} to render the second semiconductor switch conductive during the remainder of the negative half-cycle (e.g., during the non-conduction period T_{NC})

At the end of each of the positive half-cycles of the AC mains line voltage (e.g., near a zero-crossing of the AC mains line voltage), the first drive signal V_{DR1} may be driven high by the control circuit, and the first gate drive circuit may shape the first target signal V_{TRGT1} during a turn-on time period. Similarly, at the end of each of the negative half-cycles of the AC mains line voltage (e.g., near a zero-crossing of the AC mains line voltage), the second drive signal V_{DR2} by be drive high by the control circuit, and the second gate drive circuit may shape the second target signal V_{TRGT2} during a turn-on time period. Accordingly, the first and second target signals V_{TRGT1}, V_{TRGT2} may be shaped on their rising and falling edges. Alternatively, the first and second target signals V_{TRGT1}, V_{TRGT2} may only be shaped on their falling edges and not their rising edges when using the reverse phase-control dimming technique.

FIG. 5 shows examples of waveforms that illustrate operation of a gate drive circuit (e.g., the gate drive circuit 220) to render a semiconductor switch (e.g., the FET Q212) conductive using a forward phase-control dimming technique. In the waveforms of FIG. 5, the lighting load may not be experiencing an overcurrent event (e.g., the lighting load is shorted) or an inrush current event (e.g., conducting an inrush current to the lighting load). As described herein, a load control device (e.g., the load control device 100 of FIG. 1 and/or the load control device 200 of FIG. 2) may receive an AC mains line voltage from an AC power source and may use a phase control dimming technique to generate a dimmed-hot voltage V_{DH} (e.g., a phase-control voltage) at a dimmed-hot terminal of the load control device for controlling a lighting load. The load control device may comprise two gate drive circuits with a first gate drive circuit (e.g., the first gate drive circuit 115 shown in FIG. 1) controlling a first semiconductor switch (e.g., the first FET Q111) in the positive half-cycles (e.g., as shown in FIG. 5) and a second gate drive circuit (e.g., the second gate drive circuit 116 shown in FIG. 1) controlling a second semiconductor switch (e.g., the second FET Q112) in the negative half-cycles. The operation of the second gate drive circuit in the negative half-cycles may be the same as the operation of the first gate drive circuit in the positive half-cycles as shown in FIG. 5.

The gate drive circuit of the load control device may receive a drive signal V_{DR} from a control circuit (e.g., the control circuit 120 and/or the control circuit 250). The control circuit may control a magnitude of the drive signal V_{DR} high (e.g., towards the DC supply voltage V_{CC}) at a control time t_{CNTL} (e.g., a firing time). The gate drive circuit may generate a target signal V_{TRGT} in response to the drive signal V_{DR} from the control circuit. The gate drive circuit may begin to shape the target signal V_{TRGT} in response to the drive signal V_{DR} being driven high. The gate drive circuit may shape the target signal V_{TRGT} over a turn-on time period T_{T-ON} (e.g., approximately 50 microseconds). In some examples, the transition period T_{TRAN} may be equal to the turn-on time period T_{T-ON}, for example, when using forward phase-control. The gate drive circuit may generate the target signal V_{TRGT} using a turn-on signal V_{T-ON} (not shown) generated by a turn-on circuit (e.g., the turn-on circuit 226). For example, the turn-on signal V_{T-ON} may have the same shape as the target voltage V_{TRGT} during the turn-on period T_{T-ON} as shown in FIG. 5. The gate drive circuit may shape the turn-on signal V_{T-ON} in order to shape the target signal V_{TRGT}. In some examples, the turn-on signal V_{T-ON} may be defined by an “S” shape over the turn-on time period T_{T-ON}. The gate drive circuit may control the magnitude of the turn-on signal V_{T-ON} to the first limit-signal magnitude V_{MAG1} at the end of the turn-on time period T_{T-ON}. The gate drive circuit may set the target signal V_{TRGT} to be equal to the magnitude of the turn-on signal V_{T-ON} during the turn-on time period T_{T-ON}.

After the turn-on time period T_{T-ON}, the gate drive circuit may be configured to set the target signal V_{TRGT} based on the turn-on signal V_{T-ON} and a limit signal V_{LMT}. The magnitude of the limit signal V_{LMT} may range between a second magnitude (e.g., approximately the supply voltage V_{CC}) and a first magnitude (e.g., approximately circuit common or zero volts). As noted herein, the control circuit may set the magnitude of the limit signal V_{LMT} at the second magnitude or the first magnitude (e.g., or one or more values between the upper and first magnitudes) to control the magnitude of the maximum current limit I_{LMT} of the load control device. In the waveforms of FIG. 5, the magnitude of the limit signal V_{LMT} is set to the second magnitude at the end of the turn-on time period T_{T-ON}, and as such, the magnitude of the target signal V_{TRGT} may be equal to the second limit-signal magnitude V_{MAG2} at the end of the turn-on time period T_{T-ON}.

Further, after the turn-on time period T_{T-ON}, the control circuit may control the overcurrent protection enable signal V_{OCP-EN} to enable the overcurrent protection circuit. In some examples, the control circuit may control the overcurrent protection enable signal V_{OCP-EN} to enable the overcurrent protection circuit after a delay period (e.g., approximately 50 microseconds) after the end of the turn-on time period T_{T-ON}. As noted herein, the overcurrent detection circuit may be configured to control the overcurrent detection signal V_{OCD} to indicate the overcurrent condition after a trip time period T_{TRIP} from when the overcurrent condition is first detected. The control circuit may be configured to enable the overcurrent protection circuit during the conduction periods of each half-cycle, for example, as shown in FIG. 5. For example, when operating using the forward phase-control technique, the control circuit may drive the magnitude of the OCP enable signal V_{OCP-EN} high (e.g., toward the supply voltage V_{CC}) after the turn-on time period T_{T-ON}. The control circuit may drive the magnitude of the OCP enable signal V_{OCP-EN} low (e.g., toward circuit common) at and/or around the next zero-crossing event. As such, the control circuit may be configured to enable the overcurrent protection circuit during the conduction period of each half-cycle.

The gate drive circuit may generate a gate control signal V_{GC} based on the target signal V_{TRGT} and a feedback signal V_{FB} (not shown) that indicates a magnitude of a load current I_{LOAD} conducted through the semiconductor switch. The gate drive circuit may adjust a magnitude of the gate control signal V_{GC} in response to the magnitude of the feedback signal V_{FB}. For example, the gate drive circuit may adjust the magnitude of the gate control signal V_{GC} in response to a magnitude of the feedback signal V_{FB} to adjust the magnitude of the load current I_{LOAD} toward a target current, where for example, the target current is indicated by a magnitude of the target signal V_{TRGT}.

When the magnitude of the target signal V_{TRGT} is equal to the second limit-signal magnitude V_{MAG2} at the end of the turn-on time period T_{T-ON}, the gate drive circuit may control the magnitude of the gate control signal V_{GC} to attempt to control the magnitude of the load current I_{LOAD} to the second limit magnitude I_{MAG2} (e.g., approximately 20 A). However, the lighting load may not require the second limit magnitude I_{MAG2}, and the magnitude of the gate control signal V_{GC} may deviate from the magnitude of the target signal V_{TRGT}. When the magnitude of the target signal V_{TRGT} is equal the second limit magnitude I_{MAG2} after the turn-on time period T_{T-ON}, the gate drive circuit may control the magnitude of the gate control signal V_{GC} to attempt to control the magnitude of the load current I_{LOAD} to a maximum current level I_{MAX} (e.g., approximately 20 A). However, if the lighting load is not experiencing an overcurrent event (e.g., the lighting load is shorted) or an inrush current event (e.g., conducting an inrush current to the lighting load, such as an incandescent load), and an input capacitor of the lighting load does not create a surge of current, the magnitude of the gate control signal V_{GC} may not be driven up to the second limit magnitude I_{MAG2}, as shown in FIG. 5.

Since the gate drive circuit is using closed-loop control to adjust the magnitude of the gate control signal V_{GC} based on the feedback signal V_{FB}, the magnitude of the gate control signal V_{GC} may indicate (e.g., be proportional to) the present magnitude of the load current I_{LOAD}. As a result, the load current I_{LOAD} may have the same shape as the gate control signal V_{GC} as shown in FIG. 5.

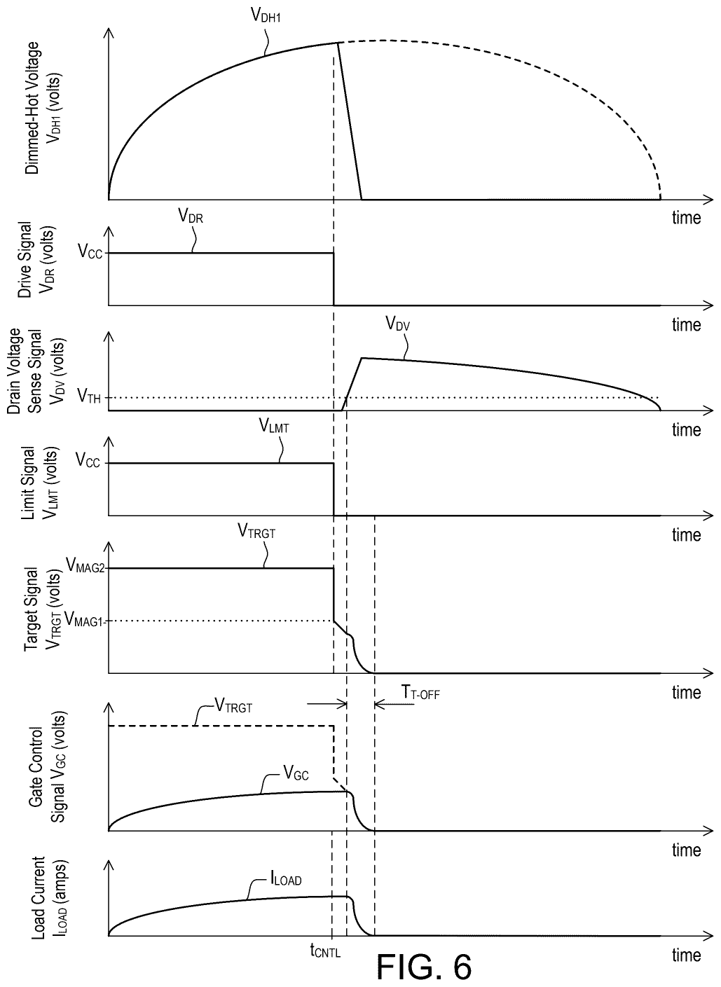

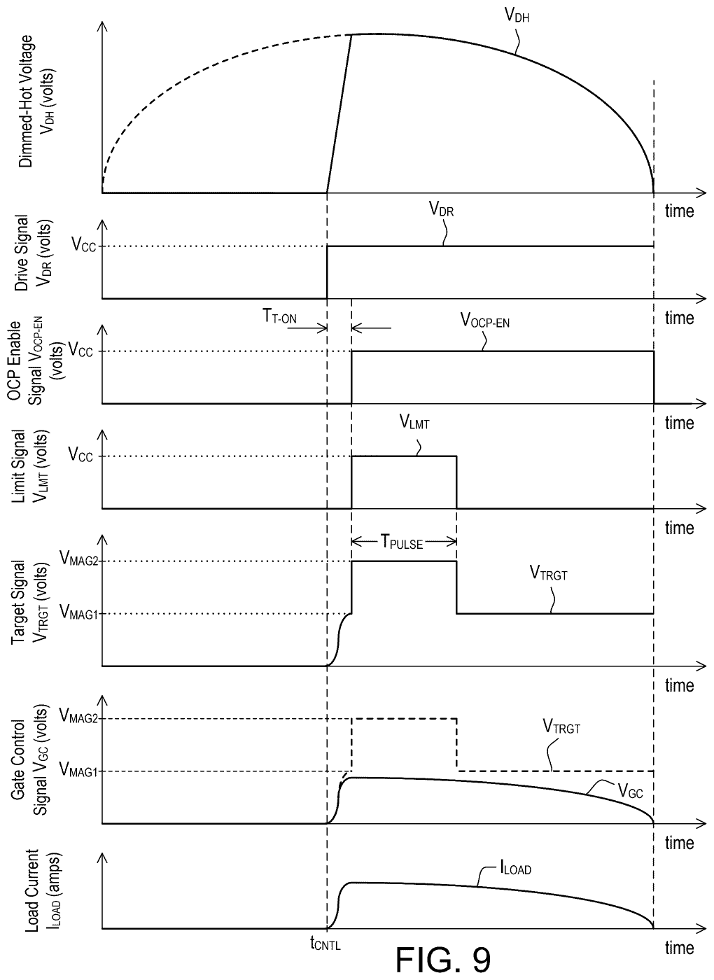

FIG. 6 shows examples of waveforms that illustrate an operation of a gate drive circuit (e.g., the gate drive circuit 220) to render a semiconductor switch (e.g., the FET Q212) non-conductive using a reverse phase-control dimming technique. A load control device (e.g., the load control device 100 of FIG. 1 and/or the load control device 200 of FIG. 2) may receive an AC mains line voltage from an AC power source and may use a phase control dimming technique to generate a dimmed-hot voltage V_{DH} (e.g., a phase-control voltage) at a dimmed-hot terminal of the load control device. The load control device may comprise two gate drive circuits with a first gate drive circuit (e.g., the first gate drive circuit 115 shown in FIG. 1) controlling a first semiconductor switch (e.g., the first FET Q111) in the positive half-cycles (e.g., as shown in FIG. 9) and a second gate drive circuit (e.g., the second gate drive circuit 116 shown in FIG. 1) controlling a second semiconductor switch (e.g., the second FET Q112) in the negative half-cycles. The operation of the second gate drive circuit in the negative half cycles may be the same as the operation of the first gate drive circuit in the positive half cycles as shown in FIG. 6. Further, it should be appreciated that the slope of the dimmed-hot voltage V_{DHI} when transitioning to zero as shown in FIG. 6 is exaggerated to illustrate the changes and correlations between the other signals shown in FIG. 6, such as the drain voltage sense signal V_{DV}, the turn-off Signal V_{T-OFF}, the target signal V_{TRGT}, the gate control signal V_{GC}, and/or the load current I_{LOAD}.

The gate drive circuit of the load control device may receive a drive signal V_{DR} from a control circuit (e.g., the control circuit 120 and/or the control circuit 250). The control circuit may drive the drive signal V_{DR} high (e.g., towards the DC supply voltage V_{CC}) at the beginning of a half-cycle of the AC mains line voltage. The gate drive circuit may generate a target signal V_{TRGT} in response to the drive signal V_{DR} from the control circuit. The control circuit may drive the drive signal V_{DR} low at a control time t_{CNTL} (e.g., a firing time). Prior to the control time t_{CNTL}, the gate drive circuit may be configured to set the target signal V_{TRGT} based on a turn-off signal V_{T-OFF} (not shown) generated by a turn-off circuit (e.g., the turn-off circuit 228) and a limit signal V_{LMT}. The magnitude of the limit signal V_{LMT} may range between a second magnitude (e.g., the supply voltage V_{CC}) and a first magnitude (e.g., approximately circuit common). As noted herein, the control circuit may set the magnitude of the limit signal V_{LMT} at the second magnitude or the first magnitude (e.g., or one or more values between the upper and first magnitudes) to control the magnitude of the maximum current limit I_{LMT} of the load control device. In the waveforms of FIG. 6, the magnitude limit signal V_{LMT} is set to the second magnitude at the beginning of the half-cycle, and as such, a magnitude of the target signal V_{TRGT} may be equal to the second limit-signal magnitude V_{MAG2}. In response to the control circuit driving the magnitude of the drive signal V_{DR} low at the control time t_{CNTL}, the gate drive circuit may decrease the magnitude of the target signal V_{TRGT} to a predetermined value, such as the first limit-signal magnitude V_{MAG1}. The magnitude of the target signal V_{TRGT} may be equal to the second limit-signal magnitude V_{MAG2} at the end of the turn-on time period T_{T-ON}.

After decreasing the magnitude of the target voltage V_{TRGT} from the second limit-signal magnitude V_{MAG2} to the first limit-signal magnitude V_{MAG1}, the gate drive circuit may decrease (e.g., gradually decrease with respect to time) the magnitude of the target signal V_{TRGT} while monitoring a characteristic of (e.g., a voltage developed across) the semiconductor switch. For example, the gate drive circuit may receive a drain voltage sense signal V_{DV} from a drain voltage sense circuit (e.g., the drain voltage sense circuit 218), where the drain voltage sense signal V_{DV} indicates a magnitude of the voltage across the semiconductor switch. When semiconductor switch is conductive, the magnitude of the voltage across the semiconductor switch is substantially small (e.g., approximately zero volts). When the magnitude of the target voltage V_{TRGT} decreases to a point that the semiconductor switch begins to become non-conductive, the magnitude of the voltage across the semiconductor switch may begin to increase causing the magnitude of the drain voltage sense signal V_{DV} to increase as shown in FIG. 6. The gate current sense circuit may determine when the magnitude of the drain voltage sense signal V_{DV} exceeds a drain voltage threshold V_{TH} (e.g., approximately 1V).

In some examples, the gate drive circuit may begin to shape the target signal V_{TRGT} from a present value towards zero volts. For example, when the gate drive circuit detects that the voltage developed across the semiconductor switch has started to increase in magnitude such that the magnitude of the drain voltage sense signal V_{DV} exceeds the drain voltage threshold V_{TH}, the gate drive circuit may begin to shape the target signal V_{TRGT} from a present value towards zero volts, for example, as shown in FIG. 6. The gate drive circuit may shape the target signal V_{TRGT} over a turn-off period T_{T-OFF} (e.g., approximately 40 microseconds). In some examples, the transition period T_{TRAN} may be equal to the turn-on time period T_{T-OFF}, for example, when using reverse phase-control. The gate drive circuit may generate the target signal V_{TRGT} using the turn off signal V_{T-OFF} generated by the turn-off circuit. For example, the turn-off signal V_{T-OFF} may have the same shape as the target voltage V_{TRGT} during the turn-off period T_{T-OFF} as shown in FIG. 6. Accordingly, the gate drive circuit may use the drain voltage sense signal V_{DV} as a trigger for the gate drive circuit to begin wave-shaping the turn-off signal V_{T-OFF} (e.g., and also the target signal V_{TGRT}). Alternatively, the gate drive circuit may wave-shape the target signal V_{TRGT} irrespective of the magnitude of the drain voltage sense signal V_{DV}. For example, the gate drive circuit may shape the target signal V_{TRGT} after (e.g., immediately after) the magnitude of the target signal V_{TRGT} is decreased from the second limit-signal magnitude V_{MAG2} to the first limit-signal magnitude V_{MAG1}. The gate drive circuit may shape the turn-off signal V_{T-OFF} (e.g., and also the target signal V_{TRGT}) in a preconfigured shape, such as a S-shape, based on the magnitude of the drain voltage sense signal V_{DV}. The gate drive circuit may shape the turn-off signal V_{T-OFF} in a first shape during a first portion of the turn-off period T_{T-OFF}, and shape the turn-off signal V_{T-OFF} in a second shape during a second portion of the turn-off period T_{T-OFF} (e.g., to create the S-shape).

The gate drive circuit may generate a gate control signal V_{GC} based on the target signal V_{TRGT} and a feedback signal V_{FB} (not shown) that indicates a magnitude of a load current I_{LOAD} conducted through a lighting load, as described herein. As described herein, the gate drive circuit may adjust a magnitude of the gate control signal V_{GC} in response to a magnitude of the feedback signal V_{FB}. For example, as shown in FIG. 6, the gate drive circuit may adjust the magnitude of the gate control signal V_{GC} in response to the magnitude of the feedback signal V_{FB}, and thereby, adjust the magnitude of the load current I_{LOAD} toward a target current. The gate drive circuit may render the semiconductor switch non-conductive by adjusting the magnitude of the gate control signal V_{GC} to zero volts, and thereby, control the magnitude of the load current through the lighting load to zero amps. Since the gate drive circuit is using closed-loop control to adjust the magnitude of the gate control signal V_{GC} based on the feedback signal V_{FB}, the magnitude of the gate control signal V_{GC} may indicate (e.g., be proportional to) the present magnitude of the load current I_{LOAD}. As a result, the load current I_{LOAD} may have the same shape as the gate control signal V_{GC} as shown in FIG. 6.

In some examples, the control circuit may control the overcurrent protection enable signal V_{OCP-EN} to enable the overcurrent protection circuit at the zero-crossing of the AC mains line voltage at the beginning of the half-cycle. As noted herein, the overcurrent detection circuit may be configured to control the overcurrent detection signal V_{OCD} to indicate the overcurrent condition after a trip time period T_{TRIP} from when the overcurrent condition is first detected. The control circuit may be configured to enable the overcurrent protection circuit during the conduction period of each half-cycle. For example, when operating using the reverse phase-control technique, the control circuit may drive the magnitude of the OCP enable signal V_{OCP-EN} high (e.g., toward the supply voltage V_{CC}) at the zero-crossing at the beginning of the half-cycle of the AC mains line voltage. The control circuit may drive the magnitude of the OCP enable signal V_{OCP-EN} low (e.g., toward circuit common) at the control time t_{CNTL}. For example, the OCP enable signal V_{OCP-EN} may be the same as to the limit signal V_{LMT} as shown in FIG. 6. As such, the control circuit may be configured to enable the overcurrent protection circuit during the conduction periods of each half-cycle.

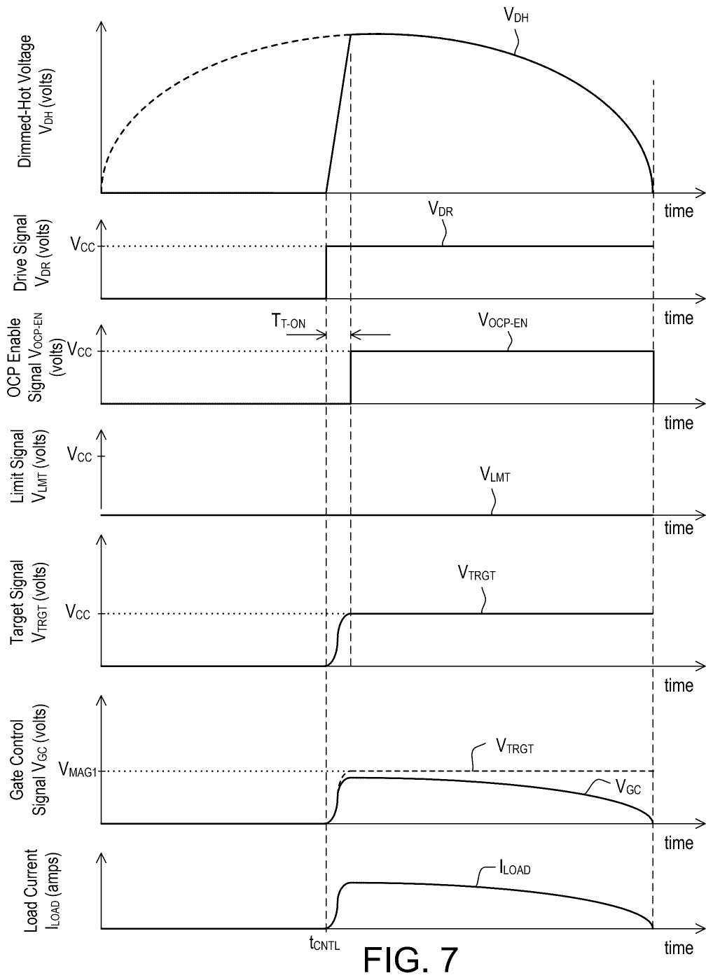

FIG. 7 shows examples of waveforms that illustrate operation of a gate drive circuit (e.g., the gate drive circuit 220) to render a semiconductor switch (e.g., the FET Q212) conductive using a forward phase-control dimming technique. Itn the waveforms of FIG. 7, the lighting load may be an inductive load. The load control device (e.g., the load control device 100 of FIG. 1 and/or the load control device 200 of FIG. 2) may receive an AC mains line voltage from an AC power source and may phase control the AC line voltage to generate a dimmed-hot voltage V_{DH} (e.g., a phase-control voltage) at a dimmed-hot terminal of the load control device for controlling a lighting load. The load control device may comprise two gate drive circuits with a first gate drive circuit (e.g., the first gate drive circuit 115 shown in FIG. 1) controlling a first semiconductor switch (e.g., the first FET Q111) in the positive half-cycles (e.g., as shown in FIG. 7) and a second gate drive circuit (e.g., the second gate drive circuit 116 shown in FIG. 1) controlling a second semiconductor switch (e.g., the second FET Q112) in the negative half-cycles. The operation of the second gate drive circuit in the negative half-cycles may be the same as the operation of the first gate drive circuit in the positive half-cycles as shown in FIG. 7.

During the operation of the gate drive circuit of FIG. 7, the control circuit may determine that the lighting load is an inductive load. The control circuit may be configured to set a magnitude of a limit signal V_{LMT} of the closed-loop gate drive circuit to the first magnitude (e.g., approximately circuit common) based on the lighting load being an inductive load. For example, the control circuit may set the magnitude of the limit signal V_{LMT} to the first magnitude during the entire conduction period of a half-cycle of the AC mains line voltage. Since the magnitude of the limit signal V_{LMT} is set to the first magnitude, the magnitude of the target signal V_{TRGT} may be set to the first limit-signal magnitude V_{MAG1} at the end of the turn-on time period, which may set the magnitude of the maximum current limit I_{LMT} to the first limit magnitude I_{MAG1} (e.g., approximately 8 A). For instance, as described with respect to FIG. 5, after the turn-on time period T_{T-ON}, the gate drive circuit may be configured to set the magnitude of the target signal V_{TRGT} based on the turn-on signal V_{T-ON} and the limit signal V_{LMT}.

Although the magnitude of the limit signal V_{LMT} may range between the second magnitude and the first magnitude, the control circuit may set the magnitude of the limit signal V_{LMT} to the first magnitude based on the lighting load being an inductive load. Since the lighting load is an inductive load, the lighting load may not need to conduct an inrush current as may be necessary by an incandescent or capacitive lighting load. Therefore, the control circuit may set the magnitude of the limit signal V_{LMT} to the first magnitude during the entire conduction period of a half-cycle of the AC mains line voltage (e.g., without raising the limit signal V_{LMT} to the second magnitude during the conductive time of the half-cycle). Further, maintaining the limit signal V_{LMT} at the first magnitude during the half-cycle may ensure that the inductive load does not overheat and/or damage because the first magnitude will prevent a load current having a large magnitude from being conducted through the inductive load and/or may prevent an asymmetrical current having a large peak magnitude above a saturation threshold from being conducted by the load.

Accordingly, when using the forward phase-control dimming technique, the control circuit may set the magnitude of the limit signal V_{LMT} to the first magnitude to adjust the magnitude of the target signal V_{TRGT} to the first limit-signal magnitude V_{MAG1} to set the magnitude of the maximum current limit I_{LMT} at a smaller magnitude, such as the first limit magnitude I_{MAG1} (e.g., approximately 8 A), to allow the overcurrent protection circuit to appropriately protect the inductive loads from large load currents.

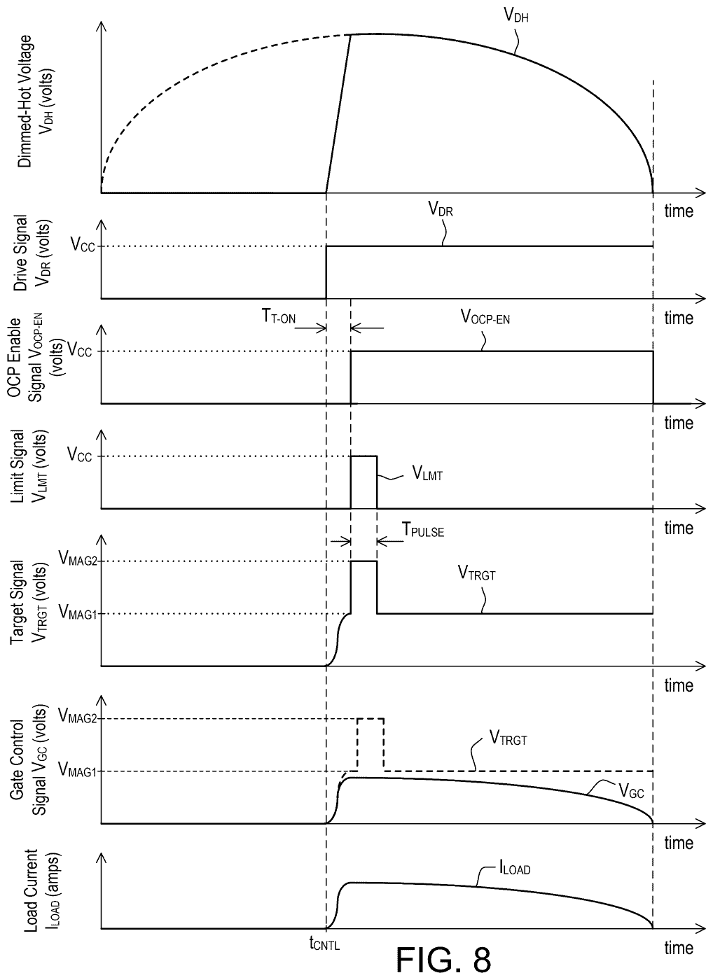

FIG. 8 shows examples of waveforms that illustrate operation of a gate drive circuit (e.g., the gate drive circuit 220) to render a semiconductor switch (e.g., the FET Q212) conductive using a forward phase-control dimming technique. In the waveforms of FIG. 8, the control circuit may be configured to adjust the limit signal V_{LMT} during the conduction period of a half-cycle of the AC mains line voltage, for example, using a pulse. For example, the control circuit may set the magnitude of the limit signal V_{LMT} to the second magnitude (e.g., the supply voltage V_{CC}) for a pulse period T_{PULSE} that starts after the control time t_{CTNL1} (e.g., after the turn-on time T_{T-ON}) and then adjust the limit signal V_{LMT} to the first magnitude (e.g., approximately circuit common) for the rest of the conduction period of the half-cycle.

The load control device (e.g., the load control device 100 of FIG. 1 and/or the load control device 200 of FIG. 2) may receive an AC mains line voltage from an AC power source and may phase control the AC line voltage to generate a dimmed-hot voltage V_{DH} (e.g., a phase-control voltage) at a dimmed-hot terminal of the load control device for controlling a lighting load. The load control device may comprise two gate drive circuits with a first gate drive circuit (e.g., the first gate drive circuit 115 shown in FIG. 1) controlling a first semiconductor switch (e.g., the first FET Q111) in the positive half-cycles (e.g., as shown in FIG. 8) and a second gate drive circuit (e.g., the second gate drive circuit 116 shown in FIG. 1) controlling a second semiconductor switch (e.g., the second FET Q112) in the negative half-cycles. The operation of the second gate drive circuit in the negative half-cycles may be the same as the operation of the first gate drive circuit in the positive half-cycles as shown in FIG. 8.

During the operation of the gate drive circuit of FIG. 8, the control circuit may set the magnitude of the limit signal V_{LMT} of the closed-loop gate drive circuit to the second magnitude (e.g., the supply voltage V_{CC}) for a pulse period T_{PULSE} that starts after the control time t_{CTNL1} and then adjust the limit signal V_{LMT} to the first magnitude (e.g., approximately circuit common) for the rest of the conduction period of the half-cycle. For example, the control circuit may set the magnitude of the limit signal V_{LMT} to the second magnitude (e.g., for the pulse period T_{PULSE} after the turn-on time T_{T-ON} and then adjust the limit signal V_{LMT} to the first magnitude at the end of the turn-on time period T_{T-ON} for the rest of the conduction period of the half-cycle. Accordingly, the target signal V_{TRGT} may be set to the second limit-signal magnitude V_{MAG2} during the pulse period T_{PULSE} and then set to the first limit-signal magnitude V_{MAG1} at the end of the pulse period T_{PULSE} and for the remainder of the conduction period of the half-cycle of the AC mains line voltage. As such, the control circuit may set the magnitude of the maximum current limit I_{LMT} to the second limit magnitude I_{MAG1} (e.g., approximately 20 A) during the pulse period T_{PULSE}, and then set the magnitude of the maximum current limit I_{LMT} to the first limit magnitude I_{MAG1} (e.g., approximately 8 A) at the end of the pulse period T_{PULSE} and for the remainder of the conduction period of the half-cycle of the AC mains line voltage. For instance, as described with respect to FIG. 5, after the turn-on time period T_{T-ON}, the gate drive circuit may be configured to set the target signal V_{TRGT} based on the turn-on signal V_{T-ON} and the limit signal V_{LMT}.

Therefore, by using the pulse period T_{PULSE} (e.g., and setting the magnitude of the limit signal V_{LMT} to the second magnitude) for a portion of the conduction period of the half-cycle of the AC mains line voltage, the control circuit is configured to allow the lighting load (e.g., should the lighting load be an incandescent load or a capacitive load) to conduct an inrush current during the pulse period T_{PULSE} because the second magnitude will allow inrush current to be conducted through the lighting load. And, by setting the limit signal V_{LMT} to the first magnitude after the pulse period T_{PULSE} and for the rest of the conduction period of the half-cycle, the control circuit is configured to allow the lighting load (e.g., should the lighting load be an inductive load) to avoid overheating and/or damage due to saturation because the first magnitude will prevent a load current having a large magnitude from being conducted through the lighting load and/or may prevent an asymmetrical current having a large peak magnitude above a saturation threshold from being conducted by the load.

Accordingly, when using the forward phase-control dimming technique, the control circuit may set the magnitude of the limit signal V_{LMT} to the second magnitude during the pulse period T_{PULSE} to adjust the magnitude of the target signal V_{TRGT} to the second limit-signal magnitude V_{MAG2} to set the magnitude of the maximum current limit I_{LMT} at a larger magnitude, such as the second limit magnitude I_{MAG2} (e.g., approximately 20 A), during the pulse period T_{PULSE} to allow for the lighting load to conduct a larger inrush current for a portion of the half-cycle, and set the magnitude of the limit signal V_{LMT} to the first magnitude after the pulse period T_{PULSE} and for the remainder of the half-cycle to adjust the magnitude of the target signal V_{TRGT} to the first limit-signal magnitude V_{MAG1} to set the magnitude of the maximum current limit I_{LMT} at a smaller magnitude, such as the first limit magnitude I_{MAG1} (e.g., approximately 8 A), to allow for the overcurrent protection circuit to appropriately protect the inductive loads from large load currents.

The length (e.g., duration) of the pulse period T_{PULSE} may be adjustable (e.g., vary in duration). For example, the control circuit may use a pulse period T_{PULSE} having a longer or shorter length during certain times and/or based on the load type. For example, in one example, the pulse period T_{PULSE} may be as long as approximately 2,000 microseconds and as short as approximately 500 microseconds. Although other pulse periods T_{PULSE} can be used. FIG. 9 shows examples of waveforms that illustrate operation of a gate drive circuit (e.g., the gate drive circuit 220) to render a semiconductor switch (e.g., the FET Q212) conductive using a forward phase-control dimming technique. In the waveforms of FIG. 9, the control circuit may be configured to adjust the limit signal V_{LMT} during the conduction period of a half-cycle of the AC mains line voltage, for example, by setting the magnitude of the limit signal V_{LMT} to a different level for a period of time. For example, the control circuit may set the magnitude of the limit signal V_{LMT} to the second magnitude (e.g., the supply voltage V_{CC}) for a pulse period T_{PULSE} that starts after the control time t_{CTNL1} (e.g., after the turn-on time T_{T-ON}) and then adjust the limit signal V_{LMT} to the first magnitude (e.g., approximately circuit common) for the rest of the conduction period of the half-cycle.

In some examples, the control circuit may set a length of the pulse period T_{PULSE} to a first time period T_{P1} (e.g., approximately 500 microseconds) to, for example, allow the capacitance of the capacitive load to appropriately charge each half-cycle or to a second time period T_{P2} (e.g., approximately 2000 microseconds) to, for example, allow an incandescent load to warm up. Further, in some examples, the control circuit may set the pulse period T_{PULSE} to the first time period T_{P1} or the second time period T_{P2} for a certain number of line cycles after powering on the lighting load (e.g., only a certain number of line cycles after powering on the lighting load). For instance, the control circuit may set the length of the pulse period T_{PULSE} to the first time period T_{P1} or the second time period T_{P2} for a number of line cycles (e.g., approximately 120 half-cycles) after turning on the lighting load, and after the first number of line cycles, the control circuit may set the magnitude of the limit signal V_{LMT} to the first magnitude for the entirety of the conduction periods of the half-cycles of future line cycles.

In some (e.g., alternative) examples, the control circuit may adjust the duration of the pulse period T_{PULSE} during operation, such as when starting up or powering on the lighting load. For instance, the control circuit may set the pulse period T_{PULSE} to the second time period T_{P2} for a first, initial number of line cycles of the AC mains line voltage (e.g., approximately 120 half-cycles), and then set the pulse period T_{PULSE} to the first time period T_{P1} for a second, subsequent number of line cycles of the AC mains line voltage (e.g., forever), where the second time period T_{P2} may be greater than the first time period T_{P1} (e.g., approximately 2,000 microseconds and approximately 500 microseconds, respectively). Therefore, the control circuit may set the duration of the pulse period T_{PULSE} to more than one value for a certain number of line cycles, for example, in response to powering on the lighting load (e.g., only a certain number of line cycles after powering on the lighting load).

The load control device (e.g., the load control device 100 of FIG. 1 and/or the load control device 200 of FIG. 2) may receive an AC mains line voltage from an AC power source and may phase control the AC line voltage to generate a dimmed-hot voltage V_{DH} (e.g., a phase-control voltage) at a dimmed-hot terminal of the load control device for controlling a lighting load. The load control device may comprise two gate drive circuits with a first gate drive circuit (e.g., the first gate drive circuit 115 shown in FIG. 1) controlling a first semiconductor switch (e.g., the first FET Q111) in the positive half-cycles (e.g., as shown in FIG. 9) and a second gate drive circuit (e.g., the second gate drive circuit 116 shown in FIG. 1) controlling a second semiconductor switch (e.g., the second FET Q112) in the negative half-cycles. The operation of the second gate drive circuit in the negative half-cycles may be the same as the operation of the first gate drive circuit in the positive half-cycles as shown in FIG. 9.

Accordingly, when using the forward phase-control dimming technique, the control circuit may set the magnitude of the limit signal V_{LMT} to the second magnitude during the pulse period T_{PULSE} to adjust the magnitude of the target signal V_{TRGT} to the second limit-signal magnitude V_{MAG2} to set the magnitude of the maximum current limit I_{LMT} at a larger magnitude, such as the second limit magnitude I_{MAG2} (e.g., approximately 20 A), during the pulse period T_{PULSE} to allow for the lighting load to conduct a larger inrush current, and set the magnitude of the limit signal V_{LMT} to the first magnitude after the pulse period T_{PULSE} and for the remainder of the half-cycle to adjust the magnitude of the target signal V_{TRGT} to the first limit-signal magnitude V_{MAG1} to set the magnitude of the maximum current limit I_{LMT} at a smaller magnitude, such as the first limit magnitude I_{MAG1} (e.g., approximately 8 A), to allow for the overcurrent protection circuit to appropriately protect the inductive loads from large load currents. Further, the control circuit may adjust the duration or the time period T_{P} of the pulse period T_{PULSE} across multiple line cycles of the AC mains line voltage during operation, such as when starting up or powering on the lighting load, for example, by reducing the duration of the pulse period T_{PULSE} from the second time period T_{P2} to the first time period T_{P1} (e.g., from approximately 2,000 μsec to approximately 500 μsec). Further, in some examples, after setting the pulse period T_{PULSE} to the second time period T_{P2} for a number of line cycles, the control circuit may stop using the pulse period T_{PULSE} altogether until the lighting load is turned off (e.g., the control circuit may reduce the limit signal V_{LMT} to the lower value (e.g., approximately circuit common)). Thus, the control circuit may gradually transition the maximum current limit I_{LMT} from a larger magnitude to a smaller magnitude (e.g., to accommodate various different types of lighting loads).

In some examples, the control device (e.g., the load control device 100 of FIG. 1 and/or the load control device 200 of FIG. 2) may include a digital-to-analog converter (DAC), and the control circuit of the control device may be configured to variably adjust (e.g., linearly adjust) the magnitude of the limit signal V_{LMT} between the second magnitude (e.g., the supply voltage V_{CC}) and the first magnitude (e.g., approximately circuit common) with respect to time during a conduction period of a half-cycle of the AC mains line voltage. For instance, the control circuit may set the magnitude of the limit signal V_{LMT} using the digital-to-analog converter, and adjust the magnitude of the limit signal V_{LMT} to adjust (e.g., linearly adjust) the magnitude of the target signal V_{TRGT} between the second limit-signal magnitude V_{MAG2} and the first limit-signal magnitude V_{MAG1}. As such, the control circuit may gradually transition the maximum current limit I_{LMT} from a larger magnitude to a smaller magnitude (e.g., to accommodate various different types of lighting loads) during a half-cycles of the AC mains line voltage.

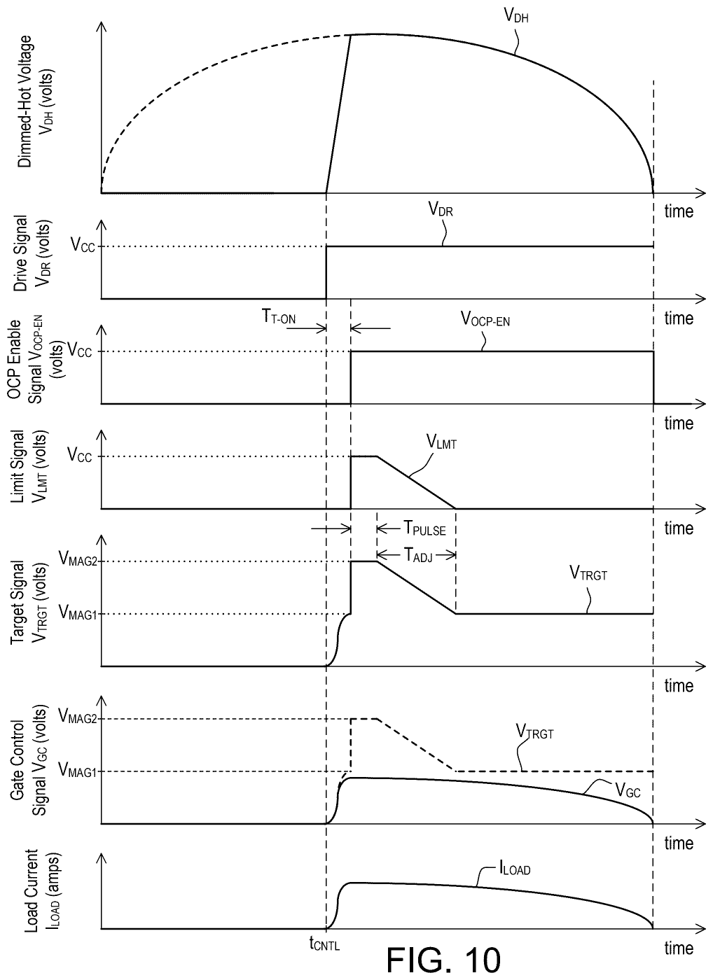

FIG. 10 illustrates examples of waveforms that illustrate the magnitude of the limit signal V_{LMT} being adjusted between the second magnitude and the first magnitude with respect to time during a conduction period of a half-cycle of the AC mains line voltage. FIG. 10 shows examples of waveforms that illustrate operation of a gate drive circuit (e.g., the gate drive circuit 220) to render a semiconductor switch (e.g., the FET Q212) conductive using a forward phase-control dimming technique. In the waveforms of FIG. 10, the control circuit may be configured to adjust the limit signal V_{LMT} during the conduction period of a half-cycle of the AC mains line voltage, for example, using a pulse. For example, the control circuit may set the magnitude of the limit signal V_{LMT} to the second magnitude (e.g., the supply voltage V_{CC}) for a pulse period T_{PULSE} that starts after the control time t_{CTNL1} (e.g., after the turn-on time T_{T-ON}), adjust the magnitude of the limit signal V_{LMT} from the second magnitude to the first magnitude (e.g., approximately circuit common or zero volts) across an adjustment period T_{ADJ}, and then maintain the magnitude of the limit signal V_{LMT} at the first magnitude for the rest of the conduction period of the half-cycle.

The load control device (e.g., the load control device 100 of FIG. 1 and/or the load control device 200 of FIG. 2) may receive an AC mains line voltage from an AC power source and may phase control the AC line voltage to generate a dimmed-hot voltage V_{DH} (e.g., a phase-control voltage) at a dimmed-hot terminal of the load control device for controlling a lighting load. The load control device may comprise two gate drive circuits with a first gate drive circuit (e.g., the first gate drive circuit 115 shown in FIG. 1) controlling a first semiconductor switch (e.g., the first FET Q111) in the positive half-cycles (e.g., as shown in FIG. 10) and a second gate drive circuit (e.g., the second gate drive circuit 116 shown in FIG. 1) controlling a second semiconductor switch (e.g., the second FET Q112) in the negative half-cycles. The operation of the second gate drive circuit in the negative half-cycles may be the same as the operation of the first gate drive circuit in the positive half-cycles as shown in FIG. 10.

As shown in FIG. 10, the control device may linearly adjust the magnitude of the limit signal V_{LMT} between the second magnitude and the first magnitude across the adjustment period T_{ADJ} during a conduction period of a half-cycle of the AC mains line voltage. Although illustrated as a linear adjustment between the second magnitude and the first magnitude, the control circuit may variably adjust the limit signal V_{LMT} using other shapes (e.g., multiple, discrete steps between the second magnitude and the first magnitude). Further, as illustrated in FIG. 10, the control circuit may set the magnitude of the limit signal V_{LMT} to the second magnitude for a pulse period T_{PULSE} after the turn-on time period T_{T-ON}. For example, the control circuit may set the length of the pulse period T_{PULSE} to the first time period T_{P1} (e.g., approximately 500 microseconds). Then, after the pulse period T_{PULSE}, the control circuit may linearly adjust the magnitude of the limit signal V_{LMT} between the second magnitude and the first magnitude during the conduction period of the half-cycle of the AC mains line voltage. Then, the control circuit may keep the limit signal V_{LMT} set to the first magnitude for the remainder of the duration of the conduction period of the half-cycle. Therefore, during the conduction period of a half-cycle of the AC mains line voltage, the control circuit may gradually transition the maximum current limit I_{LMT} from a larger magnitude to a smaller magnitude across the adjustment period T_{ADJ} (e.g., to accommodate various different types of lighting loads). The control circuit may perform the linear adjustment of the limit signal V_{LMT} between the second magnitude and the first magnitude for a certain number of half-cycles of the AC mains line voltage (e.g., a certain number after turning on the lighting load), or the control circuit may perform the linear adjustment of the limit signal V_{LMT} for all half-cycles of the AC mains line voltage.

Accordingly, when using the forward phase-control dimming technique, the control circuit may adjust the magnitude of the limit signal V_{LMT} between the second magnitude and the first magnitude across the adjustment period T_{ADJ} during the conduction period of a half-cycle of the AC mains line voltage to adjust (e.g., linearly adjust) the magnitude of the target signal V_{TRGT} between the second limit-signal magnitude V_{MAG2} and the first limit-signal magnitude V_{MAG1}, which in turn may adjust (e.g., linearly adjust) the maximum current limit I_{LMT} between the larger magnitude, such as the second limit magnitude I_{MAG2} (e.g., approximately 20 A), and the smaller magnitude, such as the first limit magnitude I_{MAG1} (e.g., approximately 8 A), across the adjustment period T_{ADJ} during the conduction period of the half-cycle of the AC mains line voltage. Doing so might allow for the lighting load to conduct a larger inrush current during the pulse period T_{PULSE} and during the adjustment period and also allow for the overcurrent protection circuit to appropriately protect the inductive loads from large load currents.

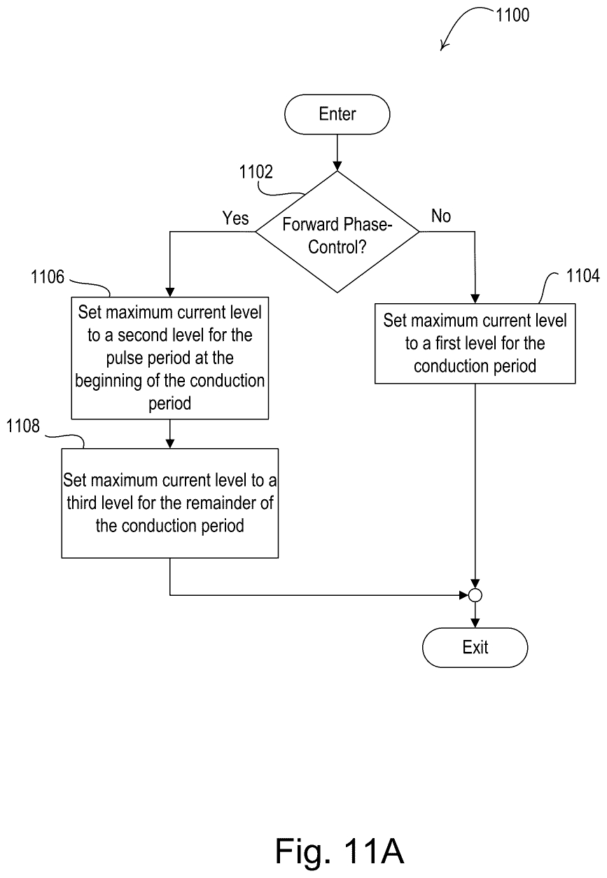

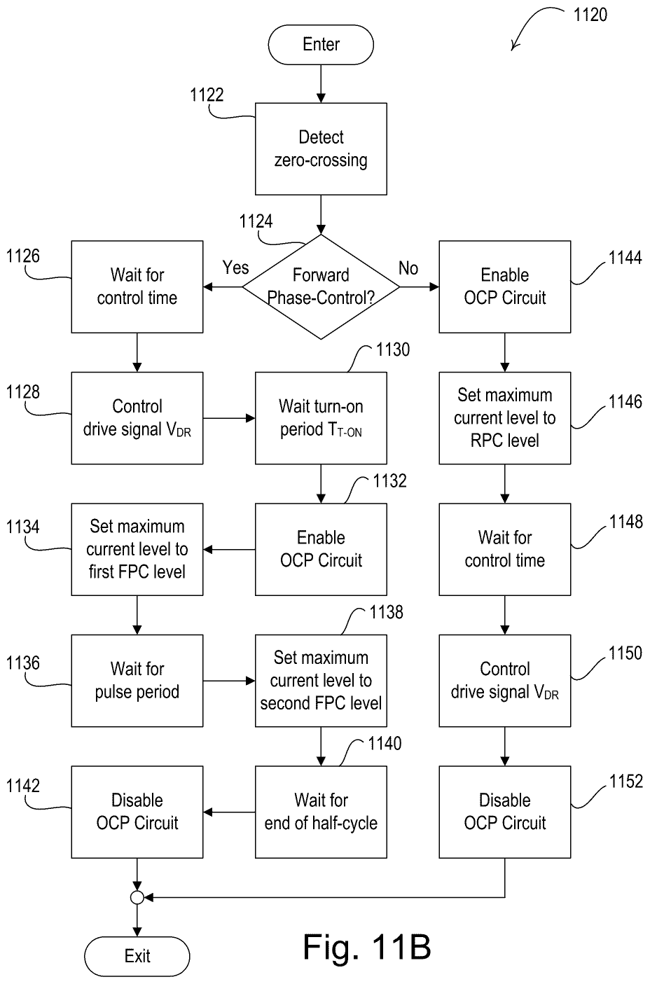

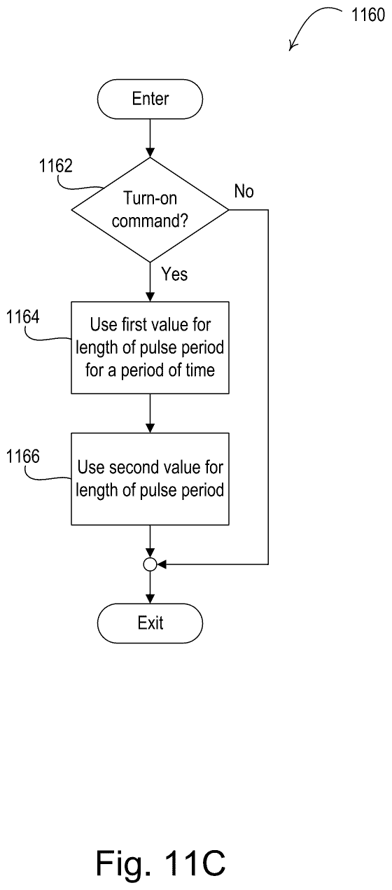

FIG. 11A is a flowchart of an example procedure 1100 for setting the maximum current limit of a load control device based on the type of phase-control technique configured by the load control device. The procedure 1100 may be performed by a control circuit (e.g., the control circuit 120 and/or the control circuit 250) of a load control device (e.g., the load control device 100 shown in FIG. 1 and/or the load control device 200 shown in FIG. 2) to control a drive circuit of the load control device (e.g., the gate drive circuit 115, the gate drive circuit 116, and/or the gate drive circuit 220). The control circuit may execute the procedure 1100 at start-up, in response to a command to control the electrical load, and/or periodically. In some examples, the control circuit may execute the procedure 1100 in response to receiving a command to control power delivered to the lighting load. Alternatively or additionally, the control circuit may execute the procedure 1100 during every half-cycle of the AC power source.

The control circuit may execute the procedure 1100 to determine how to adjust the magnitude of the limit signal V_{LMT} to control the maximum current limit I_{LMT}. As described herein, the gate drive circuit may generate the target signal V_{TRGT} based on the limit signal V_{LMT} to control a semiconductor switch to control the power delivered to the lighting load. As also described herein, the gate drive circuit may limit the magnitude of the load current I_{LOAD} conducted through the semiconductor switch to the maximum current limit I_{LMT} as indicated by the limit signal V_{LMT}. As such, the magnitude of the limit signal V_{LMT} may dictate the limit of the magnitude of the load current I_{LOAD} (e.g., the maximum current level I_{LMT}) conducted through the semiconductor switch. As described herein, the control circuit may generate the limit signal V_{LMT} at a plurality of different magnitudes, such a first limit-signal magnitude V_{MAG1} (e.g., configured to adjust the maximum current limit I_{LMT} to a first limit magnitude I_{MAG1}) and a second limit-signal magnitude V_{MAG2} (e.g., configured to adjust the maximum current limit I_{LMT} to a second limit magnitude I_{MAG2}).

At 1102, the control circuit may determine whether to control the lighting load using a forward phase-control technique. The control circuit may determine which technique to control the lighting load based on one or more factors. The control circuit may be configured (e.g., preconfigured) to use a specific phase-control technique. In some examples, the control circuit may determine the phase-control technique based on the type of lighting load that is coupled to the load control device. For example, the control circuit may determine that the lighting load is an inductive load when the magnitude of the load current I_{LOAD} conducted through the semiconductor switch (e.g., as indicated by the feedback voltage V_{FB}) is out of phase with the AC mains line voltage V_{AC} (e.g., if zero-crossings of the load current I_{LOAD} conducted through the semiconductor switch do not line up with zero-crossings of the AC mains line voltage V_{AC} as indicated by the zero-cross signal V_{ZC}).

If the control circuit determines not to control the lighting load using a forward phase-control technique (e.g., determines to control the lighting load using a reverse phase-control technique) at 1102, the control circuit may set the magnitude of the maximum current limit I_{LMT} to a first level at 1104. In some examples, the first level may be a second magnitude, such as the second limit magnitude I_{MAG2} (e.g., approximately 20 A). For instance, the control circuit may set the magnitude of the maximum current limit I_{LMT} to the first level for the entire conduction period of each half-cycle where the load control device is controlling the power delivered to the electrical load. As described herein, the control circuit may set the magnitude of the limit signal V_{LMT} to an upper value (e.g., to approximately the supply voltage V_{CC}) to adjust the magnitude of the target signal V_{TRGT} to the second limit-signal magnitude V_{MAG2}, which in turn adjusts the maximum current limit I_{LMT} to the first level. For example, as shown in the waveforms of FIG. 6, the limit signal V_{LMT} may set to the upper value at the end of the turn-on time period T_{T-ON}, and as such, the target signal V_{TRGT} may be equal to the second limit-signal magnitude V_{MAG2} at the end of the turn-on time period T_{T-ON}. As such, if the control circuit is configured to use a phase-control technique other than forward phase-control (e.g., a reverse phase-control technique or a center phase-control technique), the control circuit may set the magnitude of the maximum current limit I_{LMT} to the first level.

If the control circuit determines to control the lighting load using a forward phase-control technique at 1102, the control circuit may set the magnitude of the maximum current limit I_{LMT} to a second level for a pulse period at 1106. In some examples, the second level may be the second magnitude, such as the second limit magnitude I_{MAG2} (approximately 20 A). The control circuit may set the magnitude of the maximum current limit I_{LMT} to the second level after the turn-on time T_{T-ON} (e.g., which starts at the control time t_{CTNL1}) and for the duration of the pulse period T_{PULSE}. In some examples, the pulse period T_{PULSE} may be approximately 500 μsec.

At 1108, the control circuit may set the magnitude of the maximum current limit I_{LMT} to a third level for the remaining of the conduction period of the half-cycle of the AC mains line voltage, before existing the procedure 1100. In some examples, the third level may be equal to the first magnitude, such as the first limit magnitude I_{MAG1} (e.g., approximately 8 A). As such, the control circuit may adjust the maximum current limit I_{LMT} from the first level to the second level at the end of the pulse period T_{PULSE}, and maintain the maximum current limit I_{LMT} at the second level for the remainder of the conduction period of the half-cycle of the AC mains line voltage. The control circuit may set the magnitude of the limit signal V_{LMT} to the lower level (e.g., to approximately circuit common) to adjust the magnitude of the target signal V_{TRGT} to a first limit-signal magnitude V_{MAG1}, which in turn adjusts the maximum current limit I_{LMT} to the third level. At the beginning of the next half-cycle of the AC mains line voltage, the control circuit may restart the procedure 1100 (e.g., or revert back to 1106).

As such, the control circuit may set the magnitude of the maximum current limit I_{LMT} to the third level at the end of the pulse period T_{PULSE} and for the rest of the conduction period of the half-cycle of the AC mains line voltage. Therefore, using the procedure 1100, when using a forward phase-control technique, the control circuit may set the magnitude of the maximum current limit I_{LMT} to the second level for the pulse period T_{PULSE} to allow the capacitance of the capacitive load to appropriately charge each half-cycle and/or an incandescent load to warm up, and set the magnitude of the maximum current limit I_{LMT} to the third level at the end of the pulse period T_{PULSE} and for the rest of the conduction period of the half-cycle to ensure that an inductive load does not conduct a load current having a peak magnitude above a saturation threshold and/or may prevent an asymmetrical current having a large peak magnitude above a saturation threshold from being conducted by the load.

FIG. 11B is a flowchart of an example procedure 1120 for setting the maximum current limit of a load control device based on the type of phase-control technique configured by the load control device. The procedure 1120 may be performed by a control circuit (e.g., the control circuit 120 and/or the control circuit 250) of a load control device (e.g., the load control device 100 shown in FIG. 1 and/or the load control device 200 shown in FIG. 2) to control a drive circuit of the load control device (e.g., the gate drive circuit 115, the gate drive circuit 116, and/or the gate drive circuit 220). The control circuit may execute the procedure 1100 at start-up, in response to a command to control the electrical load, and/or periodically. In some examples, the control circuit may execute the procedure 1120 in response to receiving a command to control power delivered to the lighting load. Alternatively or additionally, the control circuit may execute the procedure 1120 during every half-cycle of the AC power source.

The control circuit may execute the procedure 1120 to determine how to control an over-current protection (OCP) circuit of the load control device (e.g., the first or second OCP circuits 117, 118 of FIG. 1 and/or the OCP circuit 230 of FIG. 2), how to control the drive signal V_{DR} provided to a gate drive circuit of the load control device (e.g., the first or second gate drive circuit 115, 116 of FIG. 1 and/or the gate drive circuit 220 of FIG. 2), and how to control the magnitude of the limit signal V_{LMT} to control the maximum current limit I_{LMT} of the load control device.

At 1122, the control circuit may detect a zero-crossing points of an AC mains line voltage V_{AC} of a AC power source. For example, the load control device may comprise a zero-crossing detect circuit (e.g., the zero-cross detect circuit 130) that may be coupled to the hot terminal H and the neutral terminal N of the load control device, and may generate a zero-cross signal V_{ZC} that indicates the zero-crossing points of the AC mains line voltage V_{AC}. As described herein, the control circuit may determine the time to render one or more semiconductor switches conductive and/or non-conductive based on the zero-crossing points of the AC mains line voltage.

At 1124, the control circuit may determine whether to control the lighting load using a forward phase-control technique. The control circuit may determine which technique to control the lighting load based on one or more factors. The control circuit may be configured (e.g., preconfigured) to use a specific phase-control technique. In some examples, the control circuit may determine the phase-control technique based on the type of lighting load that is coupled to the load control device. For example, the control circuit may determine that the lighting load is an inductive load when the magnitude of the load current I_{LOAD} conducted through the semiconductor switch (e.g., as indicated by the feedback signal V_{FB}) is out of phase with the AC mains line voltage V_{AC} (e.g., if zero-crossings of the load current I_{LOAD} as indicated by the feedback signal V_{FB} do not line up with zero-crossings of the AC mains line voltage V_{AC} as indicated by the zero-cross signal V_{ZC}).

If the control circuit determines to control the lighting load using a forward phase-control technique at 1124, the control circuit may wait for a control time t_{CNTL} at 1126. The control circuit may be configured to adjust the control time (e.g., a firing time or a phase angle) each half-cycle of the dimmed-hot voltage V_{DH} generated across the lighting load each half-cycle to control the amount of power delivered to the lighting load, and thus the present intensity level L_{PRES} of the lighting load. For example, the control circuit may be configured to adjust the control time t_{CNTL} each half-cycle to adjust the present intensity level L_{PRES} of the lighting load towards a target intensity level L_{TRGT}.

At 1128, the control circuit may control a drive signal V_{DR} that may be received by a gate drive circuit for controlling a semiconductor switch. The drive signal V_{DR} may be provided to the gate drive circuit for adjusting a control time of the dimmed-hot voltage V_{DH} generated across the lighting load and/or a magnitude of the load current I_{LOAD} conducted through the lighting load, for example, to control the present intensity level L_{PRES} of the lighting load. The control circuit may be configured to adjust a duty cycle (e.g., an on time) of the drive signal V_{DR} to adjust the present intensity level L_{PRES} of the lighting load towards a target intensity level L_{TRGT}. When operating using a forward phase-control technique (e.g., as shown in FIGS. 5 and 7-10), the control circuit may control the drive signal V_{DR} to render the semiconductor switch non-conductive (e.g., control the magnitude of the drive signal V_{DR} high towards the supply voltage V_{CC}) at the beginning of the half-cycle, and then control the drive signal V_{DR} to render the semiconductor switch conductive at the control time t_{CNTL}.

At 1130, the control circuit may wait a turn-on time period T_{T-ON} (e.g., approximately 50 microseconds). In some examples, as described herein, the control circuit may shape the target signal V_{TRGT} over the turn-on time period T_{T-ON} to shape the target signal V_{TRGT}. At 1132, the control circuit may drive the OCP enable signal V_{OCP-EN} high after the turn-on time period T_{T-ON} to enable the OCP circuit of the load control device. The control circuit may drive the OCP enable signal V_{OCP-EN} low (e.g., toward circuit common) at the next zero-crossing event. As such, the control circuit may be configured to enable the overcurrent protection circuit during the conduction periods of each half-cycle.

At 1134, the control circuit may set the magnitude of the maximum current level I_{LMT} to a first forward phase-control level. In some examples, the first forward phase-control level may be the second magnitude (e.g., approximately 20 A). As described herein, the gate drive circuit may generate the target signal V_{TRGT} based on the limit signal V_{LMT} to control a semiconductor switch to control the power delivered to the lighting load. As also described herein, the gate drive circuit may limit the magnitude of the load current I_{LOAD} conducted through the semiconductor switch to the maximum current limit I_{LMT} as indicated by the limit signal V_{LMT}. As such, the magnitude of the limit signal V_{LMT} may dictate the maximum current level I_{LMT}.

At 1136, the control circuit may set the magnitude of the maximum current limit I_{LMT} to the forward phase-control level (e.g., the second magnitude) for the duration of the pulse period T_{PULSE}. In some examples, the pulse period T_{PULSE} may be approximately 500 μsec. Further, in some examples, the control circuit may adjust the duration of the pulse period T_{PULSE}, for example, for a number of half-cycles of the AC mains line voltage after turning on the electrical load. For instance, the control circuit may be configured to set the pulse period T_{PULSE} to a second time period T_{P2} (e.g., approximately 2,000 μsec) for a number of half-cycles (e.g., approximately 120 half-cycles) after turning on the electrical load, and after the number of half-cycles, change the pulse period T_{PULSE} to a first time period T_{P1} (e.g., approximately 500 μsec) for subsequent half-cycles of the AC mains line voltage.

At 1138, the control circuit may set the magnitude of the maximum current limit I_{LMT} to a second forward phase-control level. In some examples, the second forward phase-control level may be the first magnitude (e.g., a first limit magnitude I_{MAG1}, such as approximately 8 A). The control circuit may set the magnitude of the magnitude of the limit signal V_{LMT} to the first magnitude (e.g., to approximately circuit common) to adjust the magnitude of the target signal V_{TRGT} to a first limit-signal magnitude V_{MAG1}, which in turn adjusts the maximum current limit I_{LMT} to the first magnitude.

At 1140, the control circuit may wait for the end of the half-cycle of the AC mains line voltage V_{AC}. The control circuit may detect the end of the half-cycle of the AC mains line voltage V_{AC} based on zero-crossing points of the AC mains line voltage V_{AC}. At 1142, the control circuit may disable the OCP circuit, for example, by driving the OCP enable signal V_{OCP-EN} low at the zero-crossing event of the AC mains line voltage V_{AC}. The control circuit may drive the OCP enable signal V_{OCP-EN} low (e.g., toward circuit common) to disable the OCP circuit at the beginning of the next half-cycle of the AC mains line voltage V_{AC}.

As such, the control circuit may set the magnitude of the maximum current limit I_{LMT} to the second forward phase-control level at the end of the pulse period T_{PULSE} and for the rest of the conduction period of the half-cycle of the AC mains line voltage. Therefore, using the procedure 1120, when using a forward phase-control technique, the control circuit may set the magnitude of the maximum current limit I_{LMT} to the first forward phase-control level (e.g., second magnitude) for the pulse period T_{PULSE} to allow the capacitance of the capacitive load to appropriately charge each half-cycle and/or an incandescent load to warm up, and set the magnitude of the maximum current limit I_{LMT} to the second forward phase-control level (e.g., first magnitude) at the end of the pulse period T_{PULSE} and for the rest of the conduction period of the half-cycle to ensure that an inductive load does not conduct a load current having a magnitude above a saturation threshold.

If the control circuit determines not to control the lighting load using a forward phase-control technique at 1124 (e.g., determine to control the lighting load using a reverse phase-control technique), the control circuit may enable the OCP circuit at 1144 (e.g., as described with respect to 1132). At 1146, the control circuit may set the magnitude of the maximum current level to the reverse phase-control level. In some examples, the reverse phase-control level may be the upper level (e.g., approximately 20 A). As described herein, the gate drive circuit may generate the target signal V_{TRGT} based on the limit signal V_{LMT} to control a semiconductor switch to control the power delivered to the lighting load. As also described herein, the gate drive circuit may limit the magnitude of the load current I_{LOAD} conducted through the semiconductor switch to the maximum current limit I_{LMT} as indicated by the limit signal V_{LMT}. As such, the magnitude of the limit signal V_{LMT} may dictate the maximum current level I_{LMT}.

At 1148, the control circuit may wait for a control time t_{CNTL}. The control circuit may be configured to adjust the control time t_{CNTL} (e.g., a firing time or a phase angle) each half-cycle of the dimmed-hot voltage V_{DH} generated across the lighting load each half-cycle to control the amount of power delivered to the lighting load, and thus the present intensity level L_{PRES} of the lighting load. For example, the control circuit may be configured to adjust the control time t_{CNTL} each half-cycle to adjust the present intensity level L_{PRES} of the lighting load towards a target intensity level L_{TRGT}.

At 1150, the control circuit may control a drive signal V_{DR} that may be received by a gate drive circuit for controlling a semiconductor switch. The drive signal V_{DR} may be provided to the gate drive circuit for adjusting a control time of the dimmed-hot voltage V_{DH} generated across the lighting load and/or a magnitude of the load current I_{LOAD} conducted through the lighting load, for example, to control the present intensity level L_{PRES} of the lighting load. The control circuit may be configured to adjust a duty cycle (e.g., an on time) of the drive signal V_{DR} to adjust the present intensity level L_{PRES} of the lighting load towards a target intensity level L_{TRGT}. When operating using a reverse phase-control technique (e.g., as shown in FIG. 6), the control circuit may control the drive signal V_{DR} to render the semiconductor switch conductive (e.g., control the magnitude of the drive signal V_{DR} high towards the supply voltage V_{CC}) at the beginning of the half-cycle, and then control the drive signal V_{DR} to render the semiconductor switch non-conductive at the control time t_{CNTL}.

At 1152, the control circuit may disable the OCP circuit, for example, by driving the OCP enable signal V_{OCP-EN} low, and the procedure 1120 may exit. For example, the control circuit may drive the OCP enable signal V_{OCP-EN} low at the beginning of a turn-off period T_{T-OFF}. The control circuit may drive the OCP enable signal V_{OCP-EN} high (e.g., toward circuit common) to enable the OCP circuit at the beginning of the next half-cycle of the AC mains line voltage V_{AC}.

FIG. 11C is a flowchart of an example procedure 1160 for adjusting a pulse period of a maximum current limit of a load control device in response to receiving a command to turn on the electrical load. The procedure 1160 may be performed by a control circuit (e.g., the control circuit 120 and/or the control circuit 250) of a load control device (e.g., the load control device 100 shown in FIG. 1 and/or the load control device 200 shown in FIG. 2) to control a drive circuit of the load control device (e.g., the gate drive circuit 115, the gate drive circuit 116, and/or the gate drive circuit 220). The control circuit may execute the procedure 1160 at start-up, in response to a command to control the electrical load, and/or periodically. For example, the control circuit may execute the procedure 1160 in response to a command to turn-on the electrical load. The control circuit may execute the procedure 1160 to adjust the pulse period of the maximum current limit at turn-on to accommodate different load types. The control device may perform the procedure 1160 when configured with a forward phase-control technique. The control circuit may perform the procedure 1160 in combination with other procedures described herein (e.g., the procedure 1100 and/or the procedure 1120).

At 1162, the control circuit may determine whether a turn-on command has been received. If a turn-on command has not been received, the control circuit may exit the procedure 1160. If a turn-on command is received at 1162, the control circuit may set the length (e.g., duration) of the pulse period T_{PULSE} to a first value for a first period of time at 1164. For example, as noted herein, the length (e.g., duration) of the pulse period T_{PULSE} may be adjustable. For instance, the control circuit may set the pulse period T_{PULSE} to a first time period T_{P1} for a first, initial number of line cycles of the AC mains line voltage (e.g., approximately 60 half-cycles). The first time period T_{P1} may be approximately 2,000 μsec. By setting the length of the pulse period T_{PULSE} to a first value (e.g., approximately 2,000 μsec) for a period of time (e.g., approximately 120 half-cycles), the control circuit may allow the capacitance of the capacitive load to appropriately charge each half-cycle (e.g., allow for sufficient in-rush current) and/or an incandescent load to warm up over the first period of time.

At 1166, the control circuit may set the length (e.g., duration) of the pulse period T_{PULSE} to a second value (e.g., until the electrical load is turned off), and the procedure 1160 may exit. For example, the control circuit may set the pulse period T_{PULSE} to a second time period T_{P2}. The second time period T_{P2} may be approximately 500 μsec. By setting the length of the pulse period T_{PULSE} to the second value (e.g., approximately 500 μsec) after the period of time, the control circuit may ensure that an inductive load does not conduct a load current having a magnitude above a saturation threshold.

In some examples, the control circuit may set the pulse period to the second value for a second, subsequent number of line cycles of the AC mains line voltage (e.g., approximately 60 half-cycles). In such examples, after the second, subsequent number of line cycles of the AC mains line voltage, the control circuit may be configured to reduce the limit signal V_{LMT} to the lower value (e.g., approximately circuit common), which may adjust the magnitude of the target signal V_{TRGT} to the first limit-signal magnitude V_{MAG1} for the line cycles of the AC mains line voltage after the use of the pulse period T_{PULSE}. Therefore, the control circuit may set the length of the pulse period T_{PULSE} to more than one value for a certain number of line cycles, for example, in response to powering on the lighting load (e.g., only a certain number of line cycles after powering on the lighting load).

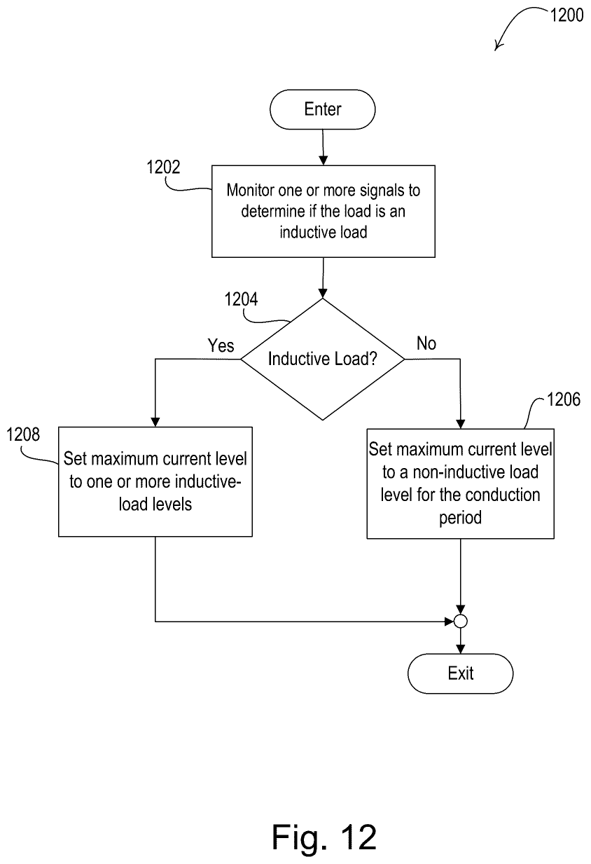

FIG. 12 is a flowchart of an example procedure 1200 for controlling a maximum current limit of a load control device based on whether an electrical load coupled to the load control device is an inductive load. The procedure 1200 may be performed by a control circuit (e.g., the control circuit 120 and/or the control circuit 250) of a load control device (e.g., the load control device 100 shown in FIG. 1 and/or the load control device 200 shown in FIG. 2) to control a drive circuit of the load control device (e.g., the gate drive circuit 115, the gate drive circuit 116, and/or the gate drive circuit 220). The control circuit may execute the procedure 1200 at start-up, in response to a command to control the electrical load, and/or periodically. The control circuit may execute the procedure 1200 to determine how to set the magnitude of the maximum current limit differently for inductive load types.

At 1202, the control circuit may monitor one or more signals to determine if the electrical load is an inductive load. For example, the control circuit may be configured to determine that the load control device is connected to an inductive load if the magnitude of the load current I_{LOAD} conducted through the semiconductor switch (e.g., as indicated by the feedback voltage V_{FB}) is out of phase with the AC mains line voltage V_{AC} (e.g., if zero-crossings of the load current I_{LOAD} as indicated by the feedback signal V_{FB} do not line up with zero-crossings of the AC mains line voltage V_{AC} as indicated by the zero-cross signal V_{ZC}). If the control circuit determines that the magnitude of the load current I_{LOAD} conducted through the semiconductor switch is in of phase with the AC mains line voltage V_{AC}, the control circuit may determine that it is not coupled to an inductive load.

If the control circuit determines that the load control device is connected to a load that is not an inductive load at 1204, the control circuit may set the magnitude of the maximum current level I_{LMT} to a non-inductive load level for the conduction period of the AC mains line voltage V_{AC} at 1206. In some examples, the non-inductive load level may be the second magnitude (e.g., approximately 20 A). As shown in FIG. 5, the gate drive circuit may generate the target signal V_{TRGT} based on the limit signal V_{LMT} to control a semiconductor switch to control the power delivered to the lighting load. As also described herein, the gate drive circuit may limit the magnitude of the load current I_{LOAD} conducted through the semiconductor switch to the maximum current limit I_{LMT} as indicated by the limit signal V_{LMT}. As such, the magnitude of the limit signal V_{LMT} may dictate the maximum current level I_{LMT}. Accordingly, when coupled to a load that is not an inductive load, such as an incandescent load or an capacitive load, the control circuit may set the magnitude of the maximum current limit I_{LMT} to a non-inductive load level to, for example, allow for the electrical load to conduct a larger inrush current for a portion of the half-cycle (e.g., in the case of a capacitive load) and/or allow the electrical load to warm up after turning on (e.g., in the case of an incandescent load).

If the control circuit determines that the load control device is connected to an inductive load at 1204, the control circuit may set the magnitude of the maximum current limit I_{LMT} to one or more inductive-load levels at 1208. In some examples, the inductive-load levels may be a single level, such as the first magnitude (e.g., approximately 8 A), for example, as shown in FIG. 7. In other examples, the inductive-load levels may be a combination of two different levels, such as the second magnitude and the first magnitude, for instance, as shown in FIGS. 8 and 9. For instance, the inductive-load levels may include a first level that is used for a pulse period T_{PULSE}, and a second level that is used for the remainder of the conduction period of the AC mains line voltage V_{AC}. Further, in some examples, the inductive-load levels may include a plurality of different levels, such that the inductive-load levels change between a first level (e.g., the second magnitude) and a second level (e.g., the first magnitude) with respect to time during a conduction period of a half-cycle of the AC mains line voltage. In some instances, the inductive-load levels may change linearly between the first and second levels over an adjustment period, for example, as shown in FIG. 10. As noted herein, when connected to an inductive load, the control circuit may be configured with a forward phase-control technique.

Accordingly, when connected to an inductive load, the control circuit may be configured to set the magnitude of the maximum current limit I_{LMT} at one or more inductive-load levels to allow the overcurrent protection circuit to appropriately protect the inductive loads from large load currents. For example, the one or more inductive-load levels may be set so as to prevent an inductive load from overheating or saturating when using a forward phase-control technique.

What is claimed is:

1. A load control device configured to control power delivered from an alternating-current (AC) power source to an electrical load, the load control device comprising:
a controllably conductive device adapted to be coupled in series between the AC power source and the electrical load, wherein the AC power source is configured to generate an AC mains line voltage, and wherein the controllably conductive device comprises a semiconductor switch configured to conduct a load current through the electrical load;
a closed-loop gate drive circuit coupled to the semiconductor switch and configured to render the semiconductor switch conductive or non-conductive at a control time during half-cycles of the AC mains line voltage, wherein the closed-loop gate drive circuit is configured to limit a magnitude of the load current conducted through the semiconductor switch to a maximum current limit; and
a control circuit configured to:
generate a drive signal to adjust the control time of the semiconductor switch during each half-cycle of the AC mains line voltage to control an amount of power delivered to the electrical load;
control the drive signal to render the semiconductor switch conductive at a control time during a half-cycle of the AC mains line voltage to maintain the semiconductor switch conductive for a conduction period during the half-cycle of the AC mains line voltage;
set the maximum current limit of the closed-loop gate drive circuit to a first limit for a period of time following the control time during the conduction period of the half-cycle of the AC mains line voltage; and
set the maximum current limit of the closed-loop gate drive circuit to a second limit after an expiration of the period of time during the conduction period of the half-cycle of the AC mains line voltage, wherein the second limit is less than the first limit.

2. The load control device of claim 1, wherein the control circuit is configured to:
set the maximum current limit to the first limit for a pulse period that starts at the control time during the half-cycle of the AC mains line voltage; and
set the maximum current limit to the second limit at an end of the pulse period and during a remainer of the conduction period of the half-cycle of the AC mains line voltage.

3. The load control device of claim 2, wherein the pulse period is approximately 500 microseconds.

4. The load control device of claim 2, wherein the control circuit is configured to set the maximum current limit to the first limit for the pulse period to allow for a capacitance of a capacitive load to charge during the half-cycle of the AC mains line voltage.

5. The load control device of claim 2, wherein the control circuit is configured to:
set the maximum current limit of the closed-loop gate drive circuit to the first limit for the pulse period following the control time of the semiconductor switch during an initial plurality of half-cycles of the AC mains line voltage after turning on the electrical load; and
after the initial plurality of half-cycles of the AC mains line voltage, set the maximum current limit of the closed-loop gate drive circuit to the second limit at the control time during subsequent half-cycles of the AC mains line voltage after the initial plurality of half-cycles and while controlling power to the electrical load.

6. The load control device of claim 5, wherein the control circuit is configured to shorten a duration of the pulse period over the initial plurality of half-cycles of the AC mains line voltage after turning on the electrical load.

7. The load control device of claim 2, wherein the control circuit is configured to:
set a length of the pulse period to a second time period for a number of half-cycles after turning on the electrical load; and
set the length of the pulse period to a first time period after the number of half-cycles and while controlling power to the electrical load.

8. The load control device of claim 7, wherein the first time period is approximately 500 microseconds, the second time period is approximately 2,000 microseconds, and the number of half-cycles is approximately 120 half-cycles.

9. The load control device of claim 2, wherein the control circuit is configured to:
adjust the maximum current limit across a range of values from the first limit to the second limit over a plurality of half-cycles of the AC mains line voltage.

10. The load control device of claim 9, wherein the control circuit is configured to:
linearly reduce the maximum current limit across the range of values from the first limit to the second limit over the plurality of half-cycles of the AC mains line voltage.

11. The load control device of claim 1, wherein, when operating in a forward phase-control technique, the control circuit is configured to:
set the maximum current limit of the closed-loop gate drive circuit to the first limit for the period of time following the control time of the semiconductor switch during a conduction period of each half-cycle of the AC mains line voltage while controlling power to the electrical load; and
set the maximum current limit of the closed-loop gate drive circuit to the second limit after an expiration of the period of time during the conduction period of each half-cycle of the AC mains line voltage while controlling power to the electrical load.

12. The load control device of claim 11, wherein, when operating in a reverse phase-control technique, the control circuit is configured to:
set the maximum current limit of the closed-loop gate drive circuit to a third limit during the entire conduction period of each half-cycle of the AC mains line voltage while controlling power to the electrical load.

13. The load control device of claim 12, wherein the third limit is equal to the first limit.

14. The load control device of claim 1, wherein the closed-loop gate drive circuit is configured to:
generate a target signal in response to the control circuit, receive a feedback signal indicative of a magnitude of the load current conducted through the semiconductor switch, and generate a gate control signal in response to the target signal and the feedback signal;
wherein the semiconductor switch of the controllably conductive device is configured to be rendered conductive and non-conductive in response to the gate control signal.

15. The load control device of claim 1, wherein, when using a forward phase-control technique, the control circuit is configured to:
control the drive signal to render the semiconductor switch non-conductive at a beginning of each half-cycle of the AC mains line voltage; and
control the drive signal to render the semiconductor switch conductive at the control time during the each half-cycle of the AC mains line voltage and throughout a remainder of each half-cycle of the AC mains line voltage while controlling power to the electrical load.

16. The load control device of claim 15, wherein, when using a reverse phase-control technique, the control circuit is configured to:
control the drive signal to render the semiconductor switches conductive at the beginning of each half-cycle of the AC mains line voltage; and
control the drive signal to render the semiconductor switch non-conductive at the control time during each half-cycle of the AC mains line voltage.

17. The load control device of claim 1, wherein the control circuit is configured to control the semiconductor switch to be non-conductive for a non-conduction period and conductive for a conduction period during one or more half-cycles of the AC mains line voltage to control the amount of power delivered to the electrical load.

18.-38. (canceled)

39. A method performed by a load control device that is configured to control power delivered from an alternating-current (AC) power source to an electrical load, the method comprising:
generating a drive signal to adjust a control time of a semiconductor switch of the load control device during each half-cycle of a AC mains line voltage to control an amount of power delivered to the electrical load;
controlling the drive signal to render the semiconductor switch conductive at a control time during a half-cycle of the AC mains line voltage to maintain the semiconductor switch conductive for a conduction period during the half-cycle of the AC mains line voltage;
setting a maximum current limit of a closed-loop gate drive circuit to a first limit for a period of time following the control time during the conduction period of the half-cycle of the AC mains line voltage, wherein the closed-loop gate drive circuit is configured to limit a magnitude of the load current conducted through the semiconductor switch to the maximum current limit; and
setting the maximum current limit of the closed-loop gate drive circuit to a second limit after an expiration of the period of time during the conduction period of the half-cycle of the AC mains line voltage, wherein the second limit is less than the first limit.

40. The method of claim 39, further comprising:
setting the maximum current limit to the first limit for a pulse period that starts at the control time during the half-cycle of the AC mains line voltage; and
setting the maximum current limit to the second limit at an end of the pulse period and during a remainer of the conduction period of the half-cycle of the AC mains line voltage.

41. (canceled)

42. (canceled)

43. The method of claim 40, further comprising:
setting the maximum current limit of the closed-loop gate drive circuit to the first limit for the pulse period following the control time of the semiconductor switch during an initial plurality of half-cycles of the AC mains line voltage after turning on the electrical load; and
after the initial plurality of half-cycles of the AC mains line voltage, setting the maximum current limit of the closed-loop gate drive circuit to the second limit at the control time during subsequent half-cycles of the AC mains line voltage after the initial plurality of half-cycles and while controlling power to the electrical load.

44.-54. (canceled)
